(19) United States
(12) Patent Application Publication
(10) Pub. No.: US 2026/0209610 A1
(43) Pub. Date: Jul. 23, 2026

(54) CATALYST FORMULATION FOR CRACKING CRUDE OILS TO PRODUCE LIGHT OLEFINS AND AROMATICS

(71) Applicant: Saudi Arabian Oil Company, Dhahran (SA)

(72) Inventors: Mansour Ali Al Herz, Dammam (SA); Anaam H. Al-ShaikhAli, Al Qatif (SA)

(73) Assignee: Saudi Arabian Oil Company, Dhahran (SA)

(21) Appl. No.: 19/034,231

(22) Filed: Jan. 22, 2025

(51) Int. Cl. C10G 11/05; C10G 11/18

(52) U.S. Cl. CPC C10G 11/05; C10G 11/182; C10G 2300/1037; C10G 2300/706; C10G 2400/20; C10G 2400/30

(57) ABSTRACT

A process for upgrading crude oil is disclosed. The process for upgrading crude oil may include passing a crude oil feed to a catalytic cracking system, including a cracking reactor. The crude oil feed may be contacted with a cracking catalyst composition in the cracking reactor. The cracking catalyst composition may include a mixture of Y-zeolite particles and cracking additive particles. The Y-zeolite particles may include silicon dioxide, aluminum oxide, iron (III) oxide, titanium (IV) oxide, phosphorous (V) pentoxide, sodium dioxide, and aluminum sulfate. The cracking additive particles may include ZSM-5 zeolite particles, aluminum phosphate, calcined Kaolin clay, aluminum oxide, and quartz. The contacting may cause at least a portion of hydrocarbons in the crude oil feed to undergo a cracking reaction, producing a cracking effluent and a used cracking catalyst composition. The cracking effluent may include light olefins, light aromatic compounds, or both.

### BACKGROUND

### Field

The present disclosure relates to processes and catalyst formulations for processing petroleum-based materials and, in particular, processes and catalyst compositions for cracking crude oil to produce light olefins and aromatics.

### Technical Background

The worldwide increasing demand for light olefins remains a major challenge for many integrated refineries. In particular, the production of some valuable light olefins, such as ethylene and propylene, has attracted increased attention as pure olefin streams are considered the building blocks for polymer synthesis. The production of light olefins depends on several process variables, such as the feed type, operating conditions, and the type of catalyst. Despite the options available for producing a greater yield of propylene and light olefins, intense research activity in this field is still being conducted. For example, light olefins are typically produced through thermal cracking (or steam pyrolysis) of petroleum gases and distillates, such as naphtha, kerosene, or gas oil. Light olefins may also be produced through fluid catalytic cracking processes. Typical hydrocarbon feeds for fluid catalytic cracking processes range from hydrocracked bottoms to heavy feed fractions such as vacuum gas oil and atmospheric residue; however, these hydrocarbon feeds are limited, at least in part, due to limitations of conventional catalysts used in fluid catalytic cracking processes.

### SUMMARY

Accordingly, there is an ongoing need for processes and catalysts for cracking alternative hydrocarbon feedstocks, such as crude oil feeds. However, contaminants, metals, or both, which can be present in crude oil and other heavy hydrocarbon feeds, can deactivate the cracking catalysts, resulting in decreased yields and increased production costs. Also, it is technically challenging to design a catalyst formulation that can crack the diverse range of hydrocarbons available at the wide boiling point range of the crude oil.

The present disclosure is directed to processes and cracking catalyst compositions for directly cracking crude oils to produce light olefins, light aromatic compounds, or both. The processes of the present disclosure include passing the crude oil feed to a cracking system comprising a cracking reactor and contacting the crude oil feed with the cracking catalyst composition in the cracking reactor under high-severity conditions. The cracking reactor can be a fixed bed cracking reactor or a fluidized catalytic cracking reactor. The cracking catalyst composition may be a blend of Y-zeolite particles and cracking additive particles. The contacting may produce a high yield of light olefins and light aromatic compounds from the crude oil feed having a wide range of boiling points without requiring pretreatment of the crude oil feed. The cracking catalyst composition may also produce high conversion of the crude oil and yield of light olefins and/or light aromatic compounds in either a fixed bed cracking reactor or a fluidized catalytic cracking reactor. The cracking catalyst compositions of the present disclosure may also reduce or prevent excessive catalytic cracking, which can lead to reduced yields of light olefins and light aromatic compounds.

According to at least one aspect of the present disclosure, a process for converting crude oil to light olefins, aromatics, or both, may include passing a crude oil feed to a catalytic cracking system. The crude oil may be a whole crude oil or a desalted crude oil. The catalytic cracking system may include a cracking reactor. The process of upgrading crude oil may additionally include contacting the crude oil feed with a cracking catalyst composition in the cracking reactor at high-severity reaction conditions. The cracking catalyst composition may include a mixture of Y-zeolite particles and cracking additive particles. The Y-zeolite particles may include silicon dioxide, aluminum oxide, iron (III) oxide, titanium (IV) oxide, phosphorous (V) pentoxide, sodium dioxide, and aluminum sulfate. The cracking additive particles may include ZSM-5 zeolite particles, aluminum phosphate, calcined Kaolin clay, aluminum oxide, and quartz. Contacting the crude oil feed with the cracking catalyst composition in the cracking reactor may cause at least a portion of hydrocarbons in the crude oil feed to undergo one or more cracking reactions to produce a cracking effluent and a used cracking catalyst composition. The cracking effluent may include light olefins, light aromatic compounds, or both.

Additional features and advantages of the aspects of the present disclosure will be set forth in the detailed description that follows and, in part, will be readily apparent to a person of ordinary skill in the art from the detailed description or recognized by practicing the aspects of the present disclosure.

### BRIEF DESCRIPTION OF THE DRAWINGS

The following detailed description of specific embodiments of the present disclosure can be best understood when read in conjunction with the following drawings, where like structure is indicated with like reference numerals, and in which:

FIG. 1 schematically depicts a generalized flow diagram of an FCC system for converting crude oil, according to aspects shown and described in the present disclosure;

FIG. 2 schematically depicts a generalized flow diagram of a fixed bed reactor system for catalytic cracking of crude oil, according to embodiments shown and described in the present disclosure;

FIG. 3 schematically depicts an ACE unit including a fluidized reactor configured to simulate a reaction in an FCC reactor, according to aspects shown and described in the present disclosure; and

FIG. 4 schematically depicts a MAT unit including a fixed bed quartz tubular reactor configured to simulate a reaction in a fixed bed reactor, according to aspects shown and described in the present disclosure.

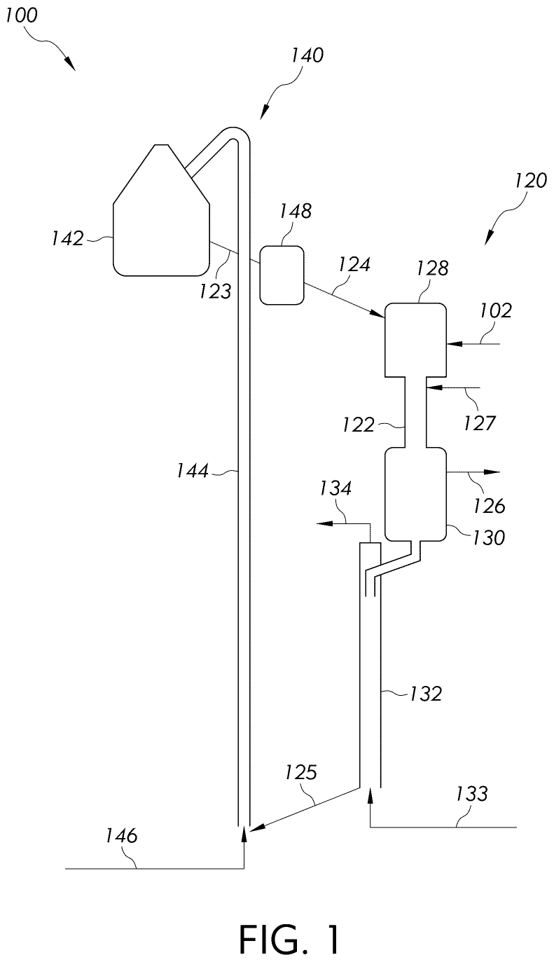

For the purpose of describing the simplified schematic illustrations and descriptions of FIGS. 1-4, some of the numerous valves, temperature sensors, electronic controllers, and the like that may be employed and well known to those of ordinary skill in the art of certain chemical processing operations may not be included. Further, accompanying components that are often included in chemical processing operations, such as, for example, air supplies, heat exchangers, surge tanks, catalyst hoppers, or other related systems may not be depicted. It would be known that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines that may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows that do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that two or more process streams are “mixed” or “combined” when two or more lines intersect in the schematic flow diagrams of FIGS. 1-4. Mixing or combining may also include mixing by directly introducing both streams into a like reactor, separation device, or other system component. For example, it should be understood that when two streams are depicted as being combined directly prior to entering a separator or reactor, that in embodiments the streams could equivalently be introduced into the separator or reactor and be mixed in the reactor.

Reference will now be made in greater detail to various embodiments of the present disclosure, some embodiments of which are illustrated in the accompanying drawings. Whenever possible, the same reference numerals will be used throughout the drawings to refer to the same or similar parts.

### DETAILED DESCRIPTION

The present disclosure is directed to cracking catalyst compositions and processes for upgrading crude oil through catalytic cracking to produce greater value chemical products and intermediates, such as but not limited to light olefins, light aromatic compounds, or combinations thereof. A crude oil feed containing hydrocarbons is passed to a catalytic cracking system where the crude oil is contacted with the cracking catalyst composition of the present disclosure. The cracking catalyst composition comprises Y-zeolite particles and cracking additive particles. The contacting causes at least a portion of the hydrocarbons in the crude oil feed to undergo a cracking reaction to produce light olefins, light aromatic compounds, or any combination of light olefins and light aromatic compounds.

The contacting may produce a high yield of light olefins and light aromatic compounds from the crude oil feed having a wide range of boiling points through catalytic cracking without requiring pretreatment of the crude oil feed. The cracking catalyst compositions of the present disclosure may reduce or prevent excessive catalytic cracking, which may lead to further cracking of greater value cracking products such as light olefins and light aromatic compounds into light hydrocarbon gases, which are of less value. The cracking catalyst compositions comprising Y-zeolite particles and cracking additive particles can also increase the conversion of the crude oil feed into light olefins, light aromatic compounds, or both. Without being bound by any particular theory, it is believed that the cracking catalyst composition comprising Y-zeolite particles and cracking additive particles comprising ZSM-5 zeolite can increase the cracking of light olefins and hydrocarbons and can reduce or prevent excessive catalytic cracking, such as continued cracking of light olefin and light aromatic product compounds. Without being bound by any particular theory, it is believed that cracking a crude oil feed using the cracking catalyst compositions of the present disclosure can increase the light olefin conversion from the crude oil feed across a wider range of boiling points. The cracking catalyst compositions and reaction conditions of the processes of the present disclosure can enable the crude oil feed to be directly converted to light olefins, aromatic compounds, or both efficiently. The cracking catalyst compositions of the present disclosure can produce high conversion (>85%) and high product yields in both a fluidized catalytic cracking system and in a fixed bed catalytic cracking system, among other features.

As used in the present disclosure, the term “cracking” refers to a chemical reaction: where a molecule having carbon-carbon bonds is broken into more than one molecule by the breaking of one or more of the carbon-carbon bonds; or where a cyclic moiety, such as an aromatic ring, is converted to a non-cyclic moiety. As used in the present disclosure, the term “catalytic cracking” refers to cracking conducted in the presence of a catalyst.

As used in this disclosure, the term “catalyst” refers to any substance that increases the rate of a specific chemical reaction. Catalysts and catalyst components described in this disclosure can be utilized to promote various reactions, such as, but not limited to catalytic cracking, aromatic cracking, other chemical reactions, or combinations of these.

As used in this disclosure, the term “used catalyst” refers to catalyst that has been contacted with reactants but has not been regenerated in a regenerator or through a regeneration process to restore at least a portion of the catalytic activity to the catalyst or increase the temperature of the catalyst. The “used catalyst” may have coke deposited on the catalyst and may include partially coked catalyst as well as fully coked catalysts. The amount of coke deposited on the “used catalyst” may be greater than the amount of coke remaining on the regenerated catalyst following regeneration. The “used catalyst” may also include catalyst that has a reduced temperature due to contact with the reactants compared to the catalyst prior to contact with the reactants.

As used in this disclosure, the term “regenerated catalyst” refers to a catalyst that has been contacted with reactants at reaction conditions and then regenerated in a regenerator or through a regeneration process to increase the catalytic activity, increase the temperature, or both of the regenerated catalyst. Increasing the catalytic activity may include oxidizing and removing at least a portion of the coke from the catalyst to restore at least a portion of the catalytic activity of the catalyst. The “regenerated catalyst” may have less coke, a greater temperature, or both, compared to used catalyst and may have greater catalytic activity compared to used catalyst.

As used in this disclosure, the term “aromatic compounds” refers to compounds having one or more aromatic ring structures. The term “light aromatic compounds” refers to compounds having an aromatic ring, with or without substitution, and from six to eight carbon atoms. The term “BTEX” refers to any combination of one or a plurality of benzene, toluene, ethylbenzene, para-xylene, meta-xylene, and ortho-xylene.

As used in this disclosure, the term “xylenes,” when used without a designation of the isomer, such as the prefix para, meta, or ortho, refers to one or more of meta-xylene, ortho-xylene, para-xylene, and mixtures of these xylene isomers.

As used in this disclosure, the terms “butenes” and “mixed butenes” refers to 1-butene, cis-2-butene, trans-2-butene, isobutene, and combinations of these. As used in this disclosure, the term “normal butenes” refers to 1-butene, cis-2-butene, trans-2-butene, and any combination thereof, but not including isobutene.

As used in this disclosure, the terms “boiling point temperature”, or “boiling temperature”, or “boiling point” refer to the temperature at which a compound or composition boils at atmospheric pressure, unless otherwise stated.

As used in this disclosure, the term “initial boiling point” or “IBP” of a composition refers to the temperature at which the constituents of the composition having the lowest boiling point temperature begin to transition from the liquid phase to the vapor phase.

As used in this disclosure, the term “final boiling point” or “FBP” of a composition refers to the temperature at which the greatest boiling temperature constituents of the composition transition from the liquid phase to the vapor phase.

As used in this disclosure, passing a stream or effluent from one unit “directly” to another unit refers to passing the stream or effluent from the first unit to the second unit without passing the stream or effluent through an intervening reaction system or separation system that substantially changes the composition of the stream or effluent. Heat transfer devices, such as heat exchangers, preheaters, coolers, condensers, or other heat transfer equipment, and pressure devices, such as pumps, pressure regulators, compressors, or other pressure devices, are not considered to be intervening systems that change the composition of a stream or effluent, unless otherwise specifically stated in the present disclosure. Combining two streams or effluents together upstream of a process unit also is not considered to comprise an intervening system that changes the composition of one or both of the streams or effluents being combined. Simply dividing a stream into two streams having the same composition is also not considered to comprise an intervening system that changes the composition of the stream. The term “directly” also refers to introducing a stream, such as a crude oil feed, to a component of the HS-FCC system without passing the stream through any preliminary components operable to change the composition of the stream, such as but not limited to a feed separator or a topping unit.

As used in this disclosure, the terms “upstream” and “downstream” refer to the relative positioning of unit operations with respect to the direction of flow of the process streams through the system. A first unit operation of a system is considered “upstream” of a second unit operation if process streams flowing through the system encounter the first unit operation before encountering the second unit operation. Likewise, a second unit operation is considered “downstream” of the first unit operation if the process streams flowing through the system encounter the first unit operation before encountering the second unit operation.

As used in this disclosure, the term “effluent” refers to a stream that is passed out of a reactor, a reaction zone, or a separator following a particular reaction or separation process. Generally, an effluent has a different composition than the stream that entered the separator, reactor, or reaction zone. It should be understood that when an effluent is passed to another system unit, only a portion of that effluent may be passed. For example, a slip stream (having the same composition) may carry some of the effluent away, meaning that only a portion of the effluent may enter the downstream system unit. The terms “reaction effluent” or “reactor effluent” are more particularly used to refer to streams that are passed out of a reactor or reaction zone.

As used in this disclosure, the term “high-severity conditions” refers to operating conditions of a fluid catalytic cracking system that include temperatures greater than or equal to 580° C., such as from 580° C. to 750° C., a catalyst-to-oil weight ratio greater than or equal to 1, such as from 1 to 60, and a contact time of less than or equal to 60 seconds, such as from 0.1 seconds to 60 seconds, each of which conditions may be more severe than operating conditions of typical fluid catalytic cracking systems.

As used in this disclosure, the term “catalyst-to-oil weight ratio” or “CTO ratio” refers to the weight ratio of the cracking catalyst to the hydrocarbons in an FCC reactor, which is determined by dividing the mass flow rate of the cracking catalyst composition to the FCC reactor by the mass flow rate of the hydrocarbons introduced to the FCC reactor.

As used in this disclosure, the term “contact time” refers to a duration of time that reactants, such as the hydrocarbons of the crude oil feed, are in contact with the cracking catalyst composition at the reaction temperature.

As used in this disclosure, the term “reactor” refers to any vessel, container, conduit, or the like, in which a chemical reaction, such as catalytic cracking, occurs between one or more reactants, optionally in the presence of one or more catalysts. A reactor can include one or a plurality of “reaction zones” disposed within the reactor. The term “reaction zone” refers to a region within a reactor where a particular reaction takes place.

As used in this disclosure, the terms “separation unit” and “separator” refers to any separation device that at least partially separates chemicals in a mixture from one another. For example, a separation unit may selectively separate different chemical species from one another, forming one or more chemical fractions. Examples of separation units include, without limitation, distillation columns, cryogenic distillation units, fractionators, flash drums, knock-out drums, knock-out pots, centrifuges, filtration devices, traps, scrubbers, expansion devices, membranes, solvent extraction devices, pressure swing adsorption units, high-pressure separators, low-pressure separators, fluid-solid separators, and the like. It should be understood that separation processes described in this disclosure may not completely separate all of one chemical consistent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided or separated into two or more process streams of desired composition.

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream, notwithstanding any inert gases or diluents purposely added to the stream). It should also be understood that components of a stream are disclosed as passing from one system component to another when a stream comprising that component is disclosed as passing from that system component to another. For example, a disclosed “olefin stream” passing to a first system component or from a first system component to a second system component should be understood to equivalently disclose the “olefin compounds” passing to the first system component or passing from a first system component to a second system component.

The composition of feed streams, the type of catalyst, type of reactor system, and reaction conditions of catalytic cracking systems play a significant role on the reaction yields and heat balance within the catalytic cracking systems. Catalytic cracking can be accomplished using a fluidized catalytic cracking (FCC) system having an FCC reactor or using a fixed bed reactor system with a fixed bed reactor. FCC systems and fixed bed catalytic cracking systems can require costly refining to produce suitable feed streams. For instance, contaminants, metals, or both, which may be present in heavy hydrocarbon feeds such as crude oil, can deactivate the catalyst, resulting in decreased yields and increased production costs. Additionally, a cracking catalyst formulation capable of cracking a diverse range of hydrocarbons can be challenging to design. Thus, crude oils are often subjected to a separation process, a pretreatment process, or both to produce a feed suitable for use in the FCC system or fixed bed catalytic cracking system. Such additional costly refining can include separating and processing of one or more fractions of a hydrocarbon feedstock, such as through hydrotreating, before introducing the refined conventional hydrocarbon feed into the cracking system. These additional processing steps are energy intensive and reduce the amount of viable feed from an existing hydrocarbon source. Further, cracking catalysts designed for use in FCC reaction systems may not be suitable for use in fixed bed cracking reactor systems.

Accordingly, aspects of the present disclosure are directed to cracking catalyst compositions and processes for converting crude oil directly to greater value chemical products and intermediates, such as, but not limited to light olefins and aromatic compounds through catalytic cracking. The cracking catalyst compositions of the present disclosure may provide for efficient cracking of the crude oil feed at reactions conditions in an FCC system or a fixed bed cracking system, while resisting deactivation of the catalyst. The cracking catalyst composition of the present disclosure is a mixture of Y-zeolite particles and cracking additive particles. The processes of the present disclosure include passing a crude oil feed to a catalytic cracking system having a catalytic cracking reactor and directly contacting the crude oil feed with the cracking catalyst composition in the catalytic cracking reactor, where the cracking catalyst composition comprises Y-zeolite particles and cracking additive particles. In embodiments, the catalytic cracking reactor may be an FCC reactor and the crude oil feed may be contacted with the cracking catalyst composition at high-severity conditions. Cracking the crude oil feed with the cracking catalyst composition of the present disclosure produces a cracking effluent comprising light olefins, light aromatic compounds, or both. Cracking the crude oil feed with the cracking catalyst composition may also produce a used cracking catalyst. In the cracking catalyst composition, the Y-zeolite particles comprise silicon dioxide, aluminum oxide, iron (III) oxide, titanium (IV) oxide, phosphorous (V) pentoxide, sodium dioxide, and aluminum sulfate. The cracking additive particles comprise ZSM-5 zeolite particles, aluminum phosphate, calcined Kaolin, aluminum oxide, and quartz.

In embodiments, the processes of the present disclosure may include contacting the crude oil feed with the cracking catalyst composition comprising a mixture of Y-zeolite particles and cracking additive particles, where the Y-zeolites comprise silicon dioxide, aluminum oxide, iron (III) oxide, titanium (IV) oxide, phosphorous (V) pentoxide, sodium dioxide, and aluminum sulfate, and the cracking additive particles comprising ZSM-5 zeolite particles, aluminum phosphate, calcined Kaolin, aluminum oxide, and quartz. The cracking catalyst composition comprising both Y-zeolite particles and cracking additive particles comprising ZSM-5 zeolite can increase the selectivity and yield of the cracking process for producing light olefins, light aromatic compounds or both, across the entire range of some unconventional hydrocarbon feeds for fluid catalytic cracking processes, such as crude oil. The cracking catalyst composition comprising Y-zeolite particles and cracking additive particles can also increase the conversion of the crude oil feed into light olefins, light aromatic compounds, or both. The cracking catalyst composition may be particularly suited for catalytically cracking crude oil under high-severity reaction conditions in an FCC reactor to produce increased olefin yield compared to conventional FCC catalysts. Additionally, cracking the crude oil feed using the cracking catalyst composition can reduce the capital costs of operation by reducing the need for pretreatment of the crude oil feed upstream of the cracking system. Without being bound by any particular theory, it is believed that the cracking catalyst composition comprising Y-zeolite particles and cracking additive particles comprising ZSM-5 zeolite can increase the cracking of light olefins and hydrocarbons and reduce or prevent excessive catalytic cracking, such as continued cracking of light olefin and light aromatic product compounds. Without being bound by any particular theory, it is believed that cracking a crude oil feed using the cracking catalyst of the present disclosure can increase the light olefin conversion from the crude oil feed across a wider range of boiling points. The cracking catalyst compositions and reaction conditions of the processes of the present disclosure can enable the crude oil feed to be directly converted to light olefins, aromatic compounds, or both efficiently. The cracking catalyst compositions of the present disclosure can produce high conversion (>85%) and high product yields in both a fluidized catalytic cracking system and in a fixed bed catalytic cracking system, among other features.

The FCC catalyst compositions and reaction conditions of the processes of the present disclosure can enable the crude oil to be directly converted to light olefins, aromatic compounds, or both efficiently, among other features.

In embodiments, the catalytic cracking system may be a high-severity fluidized catalytic cracking (HS-FCC) system. Referring now to FIG. 1, one embodiment of an HS-FCC system 100 of the present disclosure for processing a crude oil feed 102 is schematically depicted. The HS-FCC system 100 includes an FCC reactor 120 and a regenerator 140. The FCC reactor 120 contacts the crude oil feed 102 with the cracking catalyst composition 124 to produce a used cracking catalyst 125 and a cracked effluent 126. The regenerator 140 can process the used cracking catalyst 125 to produce a regenerated cracking catalyst 123, which can be recycled back to the FCC reactor 120.

The crude oil feed 102 can be a raw hydrocarbon, such as crude oil, which has not been previously processed through distillation; a crude oil that has undergone some degree of processing, such as desalting or removal of entrained solids, prior to being introduced to the HS-FCC system 100 as the crude oil feed 102; or a combination of both. The crude oil feed 102 can be a whole crude or a crude oil that has undergone at least some processing, such as desalting, solids separation, scrubbing, or combinations of these, but has not been subjected to distillation. For instance, the crude oil feed 102 can be a de-salted crude oil that has been subjected to a de-salting process. In embodiments, the crude oil feed 102 can include a crude oil that has not undergone pretreatment, separation (such as distillation), or other operation that changes the hydrocarbon composition of the crude oil prior to introducing the crude oil to the HS-FCC system 100.

In embodiments, the crude oil feed 102 can be a crude oil having an initial boiling point temperature of greater than or equal to 20° C., such as from 20° C. to 50° C., or from 20° C. to 40° C., as determined according to standard test method ASTM D7169. In embodiments, the crude oil feed 102 can be a crude oil having an end boiling point temperature of from 500° C. to 720° C., as determined according to standard test method ASTM D7169. In embodiments, the crude oil feed 102 can be a crude oil having a 50% boiling point temperature less than or equal to 350° C., such as from 200° C. to 350° C., or from 200° C. to 300° C., as determined according to standard test method ASTM D7169.

In embodiments, the crude oil feed 102 can have a concentration of paraffin compounds of less than 50 wt. %, such as less than or equal to 40 wt. %, less than or equal to 35 wt. %, less than or equal to 30 wt. %, less than or equal to 25 wt. %, or even less than or equal to 20 wt. % per unit weight of the hydrocarbon feed, as determined according to ASTM 5443. In embodiments, the crude oil feed 102 can have a concentration of paraffin compounds of from 5 wt. % to less than 50 wt. %, from 5 wt. % to 40 wt. %, from 5 wt. % to 35 wt. %, from 5 wt. % to 30 wt. %, from 5 wt. % to 25 wt. %, from 5 wt. % to 20 wt. %, from 10 wt. % to less than 50 wt. %, from 10 wt. % to 40 wt. %, from 10 wt. % to 35 wt. %, from 10 wt. % to 30 wt. %, from 10 wt. % to 25 wt. %, or even from 10 wt. % to 20 wt. % per unit weight of the crude oil feed 102.

In embodiments, the crude oil feed 102 can have a concentration of aromatic compounds of greater than or equal to 20 wt. %, greater than or equal to 30 wt. %, greater than or equal to 40 wt. %, or even greater than or equal to 50 wt. % per unit weight of the crude oil feed 102, as determined according to ASTM 5443. In embodiments, the crude oil feed 102 can have a concentration of aromatic compounds of from 20 wt. % to 90 wt. %, from 20 wt. % to 80 wt. %, from 20 wt. % to 70 wt. %, from 30 wt. % to 90 wt. %, from 30 wt. % to 80 wt. %, from 30 wt. % to 70 wt. %, from 40 wt. % to 90 wt. %, from 40 wt. % to 80 wt. %, from 40 wt. % to 70 wt. %, from 50 wt. % to 90 wt. %, from 50 wt. % to 80 wt. %, or even from 50 wt. % to 70 wt. % per unit weight of the crude oil feed 102.

In embodiments, the crude oil feed 102 can have a concentration of naphthenes of greater than or equal to 25 wt. %, or even greater than or equal to 27 wt. % per unit weight of the crude oil feed 102, as determined according to ASTM 5443. In embodiments, the crude oil feed 102 can have a concentration of naphthenes of from 25 wt. % to 60 wt. %, from 25 wt. % to 50 wt. %, from 25 wt. % to 40 wt. %, from 25 wt. % to 35 wt. %, from 27 wt. % to 60 wt. %, from 27 wt. % to 50 wt. %, from 27 wt. % to 40 wt. %, or even from 27 wt. % to 35 wt. % per unit weight of the crude oil feed 102.

The crude oil feed 102 can further include one or more non-hydrocarbon constituents, such as heavy metals, sulfur compounds, nitrogen compounds, inorganic components, or combinations of these. The crude oil feed 102 can have a concentration of nitrogen of less than or equal to 2000 parts per million by weight (ppmw), such as less than or equal to 1800 ppmw, less than or equal to 1700 ppmw, less than or equal to 1600 ppmw, or even less than or equal to 1000 ppmw. In embodiments, the crude oil feed 102 may have a concentration of nitrogen of from 0 (zero) ppmw to 2000 ppmw, from 0 ppmw to 1800 ppmw, from 0 ppmw to 1700 ppmw, from 0 ppmw to 1600 ppmw, from 0 ppmw to 1000 ppmw, from 200 ppmw to 2000 ppmw, from 200 ppmw to 1800 ppmw, from 200 ppmw to 1700 ppmw, from 200 ppmw to 1600 ppmw, from 200 ppmw to 1000 ppmw, from 500 ppmw to 2000 ppmw, from 500 ppmw to 1800 ppmw, from 500 ppmw to 1700 ppmw, from 500 ppmw to 1600 ppmw, or even from 500 ppmw to 1000 ppmw, based on the total weight of the crude oil feed 102.

In embodiments, the crude oil feed 102 includes only crude oil. The crude oil can have an American Petroleum Institute (API) gravity of from 15 degrees to 50 degrees, such as from 20 degrees to 50 degrees, from 20 degrees to 40 degrees, from 20 degrees to 35 degrees, from 25 degrees to 50 degrees, from 25 degrees to 40 degrees, from 25 degrees to 35 degrees, from 30 degrees to 50 degrees, from 30 degrees to 46 degrees, from 30 degrees to 45 degrees, from 30 degrees to 44 degrees, from 30 degrees to 42 degrees, from 30 degrees to 40 degrees, from 30 degrees to 35 degrees, from 35 degrees to 50 degrees, from 35 degrees to 45 degrees, from 35 degrees to 44 degrees, from 35 degrees to 42 degrees, from 35 degrees to 40 degrees, from 36 degrees to 50 degrees, from 36 degrees to 45 degrees, from 36 degrees to 44 degrees, from 36 degrees to 42 degrees, from 36 degrees to 40 degrees, from 38 degrees to 45 degrees, from 38 degrees to 44 degrees, from 38 degrees to 42 degrees, from 40 degrees to 50 degrees, from 40 degrees to 45 degrees, or from 40 degrees to 42 degrees. The crude oil can have a density of greater than or equal to 0.8 grams per cubic centimeter (g/cm³), greater than or equal to 0.82 g/cm³, greater than or equal to 0.84 g/cm³, or even greater than or equal to 0.85 g/cm³ as measured at 15° C. In embodiments, the crude oil can have a density of less than or equal to 1.0 g/cm³, less than or equal to 0.95 g/cm³, less than or equal to 0.90 g/cm³, less than or equal to 0.88 g/cm³, or even less than or equal to 0.86 g/cm³, as measured at 15° C.

In embodiments, the crude oil feed 102 comprises, consists of, or consists essentially of a light crude oil, such as AL crude oil from Saudi Arabia. The light crude oil may have an API gravity of from 30 degrees to 35 degrees, such as from 30 degrees to 34 degrees, from 30 degrees to 33 degrees, from 31 degrees to 35 degrees, from 31 degrees to 34 degrees, from 31 degrees to 33 degrees, as determined according to the standard test method in ASTM D287. The light crude oil can have a density of from 0.85 g/cm³ to 0.90 g/cm³, from 0.85 g/cm³ to 0.89 g/cm³, from 0.85 g/cm³ to 0.88 g/cm³, from 0.85 g/cm³ to 0.87 g/cm³, from 0.86 g/cm³ to 0.90 g/cm³, from 0.86 g/cm³ to 0.89 g/cm³, from 0.86 g/cm³ to 0.88 g/cm³, or from 0.86 g/cm³ to 0.87 g/cm³, as measured at 15 degrees Celsius according to the standard test method in ASTM 287.

The light crude oil may have a nitrogen content of less than or equal to 1600 parts per million by weight (ppmw), such as less than or equal to 1000 ppmw, from 500 ppmw to 1600 ppmw, or from 500 ppmw to 1000 ppmw, per unit weight of the light crude oil. The nitrogen content of the light crude oil may be determined according to the standard test method in ASTM 4629. The light crude oil may have a sulfur content of less than or equal to 2.4 weight percent (wt. %), such as from 1.9 wt. % to 2.4 wt. %, per unit weight of the light crude oil, as determined according to the standard test method in ASTM D4294.

The light crude oil may include heavy metals, such as but not limited to vanadium, nickel, or iron. The light crude oil may have a vanadium content of less than 30 ppmw, less than 25 ppmw, or even less than 20 ppmw, per unit weight of the light crude oil. The light crude oil may have a nickel content of less than 15 ppmw, or less than or equal to 10 ppmw, per unit weight of the light crude oil. The light crude oil may have less than 5 ppmw iron, such as less than 2 ppmw iron, per unit weight of the light crude oil. The content of the various metals in the light crude oil may be determined according to the standard test method in IP 501.

The light crude oil may be characterized by a distillation profile determined according to the standard test method in ASTM D7169. The light crude oil may have an initial boiling point temperature (IBP) of 20° C. to 40° C., such as from 20° C. to 30° C., from 20° C. to 25° C., from 25° C. to 40° C., from 25° C. to 30° C., or from 30° C. to 40° C., as determined according to ASTM D7169. The light crude oil may have an end boiling point temperature (EBP) of less than 720° C., such as from 500° C. to 720° C., from 550° C. to 720° C., or from 600° C. to 720° C., as determined according to ASTM D7169. The light crude oil may have a 5 wt. % boiling point temperature of less than or equal to 80° C., such as from 20° C. to 80° C., from 20° C. to 70° C., from 20° C. to 50° C., from 30° C. to 80° C., from 30° C. to 70° C., or from 30° C. to 50° C., as determined according to standard test method ASTM D7169. The light crude oil may have a 50 wt. % boiling point temperature of from 290° C. to 350° C., such as from 290° C. to 330° C., or from 290° C. to 310° C., as determined according to standard test method ASTM D7169. The crude oil feed 102 may have a 90 wt. % boiling point temperature of from 550° C. to 700° C., such as from 550° C. to 650° C., from 550° C. to 600° C., or from 600° C. to 700° C., as determined according to standard test method ASTM D7169. Properties for an AL crude oil that may be suitable as a light crude oil for the crude oil feed 102 are provided in Table 1.

In embodiments, the crude oil feed 102 comprises, consists of, or consists essentially of an extra light crude oil, such as AXL crude oil from Saudi Arabia. The extra light crude oil may have an API gravity greater than the API gravity of the light crude oil and less than the API gravity of a gas condensate. The extra light crude oil may have an API gravity of from 35 degrees to 45 degrees, such as from 35 degrees to 42 degrees, from 38 degrees to 45 degrees, from 38 degrees to 42 degrees, from 40 degrees to 45 degrees, or from 40 degrees to 42 degrees, as determined according to the standard test method in ASTM D287. The extra light crude oil has a density that is less than the density of a light crude oil and greater than a density of a gas condensate. The extra light crude oil can have a density of less than 0.85 g/cm³, such as less than or equal to 0.84 g/cm³, less than or equal to 083 g/cm³, from 0.80 g/cm³ to 0.85 g/cm³, from 0.80 g/cm³ to 0.84 g/cm³, from 0.80 g/cm³ to 0.83 g/cm³, from 0.81 g/cm³ to 0.85 g/cm³, from 0.81 g/cm³ to 0.84 g/cm³, or from 0.81 g/cm³ to 0.83 g/cm³, as measured at 15° C. according to the standard test method in ASTM D4052.

The extra light crude oil may have a nitrogen content of less than or equal to 1000 parts per million by weight (ppmw), such as less than or equal to 800 ppmw, less than or equal to 500 ppmw, from 0 ppmw to 1000 ppmw, or from 0 ppmw to 800 ppmw, or from 0 ppmw to 500 ppmw per unit weight of the extra light crude oil, as determined according to the standard test method in ASTM 4629. The nitrogen content of the extra light crude oil may be less than the nitrogen content in a light crude oil. The extra light crude oil may have a sulfur content of less than or equal to 2.4 weight percent (wt. %), less than or equal to 2.2 wt. %, less than or equal to 2.0 wt. %, or less than or equal to 1.8 wt. %, per unit weight of the extra light crude oil, as determined according to the standard test method in ASTM D4294. The sulfur content in the extra light crude oil may be less than the sulfur content in the light crude oil. The extra light crude oil may have a vanadium content of less than 30 ppmw, less than 25 ppmw, or even less than 20 ppmw, per unit weight of the extra light crude oil. The extra light crude oil may have a nickel content of less than 15 ppmw, or less than or equal to 10 ppmw, per unit weight of the extra light crude oil. The extra light crude oil may have less than 5 ppmw iron, such as less than 2 ppmw iron, per unit weight of the extra light crude oil. The content of the various metals in the extra light crude oil may be determined according to the standard test method in IP 501.

The extra light crude oil may be characterized by a distillation profile determined according to the standard test method in ASTM D7169. The extra light crude oil may have an initial boiling point temperature (IBP) of 15° C. to 30° C., such as from 15° C. to 25° C., from 20° C. to 30° C., or from 20° C. to 25° C., as determined according to ASTM D7169. The IBP of the extra light crude oil may be less than the IBP of the light crude oil. The extra light crude oil may have an end boiling point temperature (EBP) of less than 720° C., such as from 500° C. to 720° C., from 550° C. to 720° C., or from 600° C. to 720° C., as determined according to ASTM D7169. The extra light crude oil may have a 5 wt. % boiling point temperature that is less than or equal to 80° C., such as from 20° C. to 80° C., from 20° C. to 70° C., from 20° C. to 50° C., from 30° C. to 80° C., from 30° C. to 70° C., or from 30° C. to 50° C., as determined according to standard test method ASTM D7169. The extra light crude oil may have a 50 wt. % boiling point temperature of from 200° C. to 290° C., such as from 200° C. to 280° C., from 200° C. to 270° C., from 220° C. to 290° C., from 220° C. to 280° C., from 220° C. to 270° C., from 250° C. to 290° C., from 250° C. to 280° C., or from 250° C. to 270° C., as determined according to standard test method ASTM D7169. The 50 wt. % boiling point temperature of the extra light crude oil may be less than the 50 wt. % boiling point temperature of the light crude oil. The extra light crude oil may have a 90 wt. % boiling point temperature of from 400° C. to 550° C., such as from 400° C. to 525° C. from 400° C. to 500° C., from 425° C. to 550° C., from 425° C. to 525° C., from 425° C. to 5000° C., from 450° C. to 550° C., from 450° C. to 525° C., or from 450° C. to 500° C., as determined according to standard test method ASTM D7169. The 90 wt. % boiling point temperature of the extra light crude oil may be less than the 90 wt. % boiling point temperature of the light crude oil. Properties for an AXL crude oil that may be suitable as an extra light crude oil for the crude oil feed 102 are provided in Table 1.

TABLE 1
Properties of AL Crude Oil and AXL Crude Oil

| | | AL Crude | AXL Crude | Test |
|---|---|---|---|---|
| Analysis | Units | Oil | Oil | Method |
| American | degree | 33.9 | 40.5 | ASTM D287 |
| Petroleum | | | | |
| Institute (API) | | | | |
| gravity | | | | |
| Density | grams per | 0.860 | 0.822 | ASTM D4052 |
| (@15.6° C.) | cubic | | | |
| | centimeter | | | |
| | (g/cm³) | | | |
| Sulfur Content | wt. % | 2.088 | 1.697 | ASTM D4294 |
| Nitrogen | parts per | 1523 | 297 | ASTM D4629 |
| Content | million by | | | |
| | weight | | | |
| | (ppmw) | | | |
| Sodium (Na) | ppmw | <1 | <1 | IP 501 |
| Content | | | | |
| Vanadium (V) | ppmw | 17 | 8 | IP 501 |
| Content | | | | |
| Nickel (Ni) | ppmw | 5 | 2 | IP 501 |
| Content | | | | |
| Iron (Fe) | ppmw | 2 | <1 | IP 501 |
| Content | | | | |
| Paraffins | wt. % | 31 | 30.7 | ASTM D5443 |
| Naphthenes | wt. % | 11 | 11.8 | ASTM D5443 |
| Aromatics | wt. % | 57.8 | 57.5 | ASTM D5443 |

Boiling Point Distribution

| | | | | |
|---|---|---|---|---|
| 5% Boiling | ° C. | 37.22 | 36.67 | SIMDIST/ |
| Point (BP) | | | | ASTM D7169 |
| 10% BP | ° C. | 87.22 | 86.11 | SIMDIST/ |
| | | | | ASTM D7169 |
| 20% BP | ° C. | 126.11 | 125.00 | SIMDIST/ |
| | | | | ASTM D7169 |
| 30% BP | ° C. | 183.33 | 178.89 | SIMDIST/ |
| | | | | ASTM D7169 |
| 40% BP | ° C. | 233.89 | 238.33 | SIMDIST/ |
| | | | | ASTM D7169 |
| 50% BP | ° C. | 292.78 | 286.11 | SIMDIST/ |
| | | | | ASTM D7169 |
| 60% BP | ° C. | 346.67 | 337.22 | SIMDIST/ |
| | | | | ASTM D7169 |
| 70% BP | ° C. | 407.22 | 393.33 | SIMDIST/ |
| | | | | ASTM D7169 |
| 80% BP | ° C. | 472.78 | 453.89 | SIMDIST/ |
| | | | | ASTM D7169 |
| 90% BP | ° C. | 557.22 | 531.67 | SIMDIST/ |
| | | | | ASTM D7169 |
| End Boiling | ° C. | 719 | 719 | SIMDIST/ |
| Point (EBP) | | | | ASTM D7169 |

Weight percentages in Table 1 are based on the total weight of the crude oil.

The processes of the present disclosure include passing the crude oil feed 102 to an HS-FCC system 100 comprising the cracking catalyst composition 124. The cracking catalyst composition 124 of the present disclosure includes a mixture of Y-zeolite particles and cracking additive particles, the cracking additive particles comprising a ZSM-5 zeolite. The Y-zeolite particles may comprise silicon dioxide (silica, SiO₂), aluminum oxide (alumina, Al₂O₃), iron (III) oxide, titanium (IV) oxide, phosphorous (V) pentoxide, sodium dioxide, and aluminum sulfate. The cracking additive particles may comprise a ZSM-5 zeolite, aluminum phosphate, calcined Kaolin clay, aluminum oxide, and quartz (silica (SiO₂)).

As used in the present disclosure, “Y-zeolite” refers to zeolite having a FAU framework type according to the International Union of Pure and Applied Chemistry (IUPAC) zeolite nomenclature and consisting of silica and alumina. The Y-zeolite particles of the cracking catalyst composition 124 may be operable to crack at least a portion of the crude oil feed 102 to produce one or more light olefins, such as ethylene and propylene. Without being bound by any particular theory, it is believed that the Y-zeolite may have a greater propensity to crack the relatively heavier hydrocarbon chains. As a result, the inclusion of the Y-zeolite may increase the yield of products, such as light olefins, when compared to cracking catalysts that do not include Y-zeolite, especially when included in conjunction with ZSM-5 zeolite.

The Y-zeolite particles may comprise Y-zeolite having a molar ratio of silica (SiO₂) to alumina (Al₂O₃) of greater than or equal to 2, such as greater than or equal to 3, or even greater than or equal to 5. In embodiments, the Y-zeolite may have a molar ratio of silica to alumina of from 2 to 30, from 2 to 25, from 2 to 20, from 2 to 15, from 3 to 30, from 3 to 25, from 3 to 20, from 3 to 15, from 5 to 30, from 5 to 25, from 5 to 20, from 5 to 15, from 12 to 30, or from about 15 to about 30. The Y-zeolite particles may have a concentration of silica of from 72 wt. % to 82 wt. % based on the total weight of the Y-zeolite particles. In embodiments, the Y-zeolite particles may comprise from 72 wt. % to 80 wt. %, from 72 wt. % to 78 wt. %, from 72 wt. % to 77 wt. %, from 74 wt. % to 82 wt. %, from 74 wt. % to 80 wt. %, from 74 wt. % to 78 wt. %, from 74 wt. % to 77 wt. %, from 76 wt. % to 82 wt. %, from 76 wt. % to 80 wt. %, from 76 wt. % to 78 wt. %, from 76 wt. % to 77 wt. %, from 77 wt. % to 82 wt. %, from 77 wt. % to 80 wt. %, from 77 wt. % to 78 wt. %, or about 77 wt. % silica based on the total weight of the Y-zeolite particles.

The Y-zeolite particles may comprise a concentration of alumina of from 16 wt. % to 26 wt. % based on the total weight of the Y-zeolite particles. In embodiments, the Y-zeolite particles may comprise from 16 wt. % to 24 wt. %, from 16 wt. % to 22 wt. %, from 16 wt. % to 21 wt. %, from 18 wt. % to 26 wt. %, from 18 wt. % to 24 wt. %, from 18 wt. % to 22 wt. %, from 18 wt. % to 21 wt. %, from 20 wt. % to 26 wt. %, from 20 wt. % to 24 wt. %, from 20 wt. % to 22 wt. %, from 20 wt. % to 21 wt. %, from 21 wt. % to 26 wt. %, from 21 wt. % to 24 wt. %, from 21 wt. % to 22 wt. %, or about 21 wt. % alumina based on the total weight of the Y-zeolite particles.

In addition to the silica and alumina in the Y-zeolite, the Y-zeolite particles may further comprise iron (III) oxide (Fe₂O₃), titanium (IV) oxide (TiO₂), phosphorous (V) pentoxide (P₂O₅), sodium dioxide (Na₂O), aluminum sulfate (Al₂(SO₄)₃), or any combinations of these constituents. The Fe₂O₃, TiO₂, P₂O₅, NaO₂, Al₂(SO₄)₃, or combinations thereof may be available at the surfaces of the Y-zeolite particles, such as at the outer surfaces, pore surfaces, or both of the Y-zeolite particles. The Fe₂O₃, TiO₂, P₂O₅, NaO₂, Al₂(SO₄)₃, or combinations thereof may be impregnated, deposited, or otherwise placed onto the outer surface, pore surfaces, or both of the Y-zeolite particles, or may be incorporated into the zeolite matrix of the Y-zeolite particles, such that the Fe₂O₃, TiO₂, P₂O₅, NaO₂, Al₂(SO₄)₃, or combinations thereof are available at the surfaces of the Y-zeolite particles.

In embodiments, the Y-zeolite particles may comprise Fe₂O₃. The Y-zeolite particles may include from 0 (zero) wt. % to 0.9 wt. % Fe₂O₃ based on the total weight of the Y-zeolite particles. In embodiments, the Y-zeolite particles may comprise from greater than 0 wt. % to 0.9 wt. %, or from 0.1 wt. % to 0.9 wt. % Fe₂O₃ based on the total weight of the Y-zeolite particles. In embodiments, the Y-zeolite particles may comprise TiO₂. The Y-zeolite particles may include from 0 (zero) wt. % to 0.9 wt. % TiO₂ based on the total weight of the Y-zeolite particles. In embodiments, the Y-zeolite particles may comprise from greater than 0 wt. % to 0.9 wt. %, such as from 0.1 wt. % to 0.9 wt. % TiO₂ based on the total weight of the Y-zeolite particles.

In embodiments, the Y-zeolite particles may comprise P₂O₅. The Y-zeolite particles may include from 0 (zero) wt. % to 0.8 wt. % P₂O₅ based on the total weight of the Y-zeolite particles. In embodiments, the Y-zeolite particles may comprise from greater than 0 wt. % to 0.8 wt. %, such as from 0.1 wt. % to 0.8 wt. % P₂O₅ based on the total weight of the Y-zeolite particles. Without being bound by any particular theory, it is believed that phosphorus-containing compounds may stabilize the structure of a zeolitic framework structure by preventing the segregation of the framework alumina, which can improve the hydrothermal stability of the zeolitic component. This may reduce the dealumination of the zeolitic component that occurs during steaming, which can lead to a reduction in acidity and catalytic activity of the zeolitic component.

In embodiments, the Y-zeolite particles may comprise Na₂O. The Y-zeolite particles may include from 0 (zero) wt. % to 0.5 wt. % Na₂O based on the total weight of the Y-zeolite particles. In embodiments, the Y-zeolite particles may comprise from greater than 0 wt. % to 0.5 wt. %, such as from 0.1 wt. % to 0.5 wt. % Na₂O based on the total weight of the Y-zeolite particles. In embodiments, the Y-zeolite particles may comprise aluminum sulfate. The Y-zeolite particles may include from 0 (zero) wt. % to 0.5 wt. % aluminum sulfate based on the total weight of the Y-zeolite particles. In embodiments, the Y-zeolite particles may comprise from greater than 0 wt. % to 0.5 wt. %, such as from 0.1 wt. % to 0.5 wt. % aluminum sulfate based on the total weight of the Y-zeolite particles.

In embodiments, the Y-zeolite particles may comprise, consist of, or consist essentially of SiO₂, Al₂O₃, Fe₂O₃, TiO₂, P₂O₅, Na₂O, and aluminum sulfate. In embodiments, the Y-zeolite particles may comprise, consist of, or consist essentially of from 72 wt. % to 82 wt. % SiO₂, from 16 wt. % to 26 wt. % Al₂O₃, from greater than 0 wt. % to 0.9 wt. % Fe₂O₃, from 0.1 wt. % to 0.9 wt. % TiO₂, from greater than 0 wt. % to 0.8 wt. % P₂O₅, from greater than 0 wt. % to 0.5 wt. % Na₂O, and from greater than 0 wt. % to 0.5 wt. % aluminum sulfate, based on the total weight of the Y-zeolite particles. In embodiments, the Y-zeolite particles may comprise, consist of, or consist essentially of 77 wt. % SiO₂, 21 wt. % Al₂O₃, from greater than 0 wt. % to 0.9 wt. % Fe₂O₃, from 0.1 wt. % to 0.9 wt. % TiO₂, from greater than 0 wt. % to 0.8 wt. % P₂O₅, from greater than 0 wt. % to 0.5 wt. % Na₂O, and from greater than 0 wt. % to 0.5 wt. % aluminum sulfate, based on the total weight of the Y-zeolite particles. In embodiments, the Y-zeolite particles may be HS-FCC-5a cracking catalyst available from JGC Catalyst and Chemicals Ltd. of Kawasaki City, Japan.

In embodiments, the Y-zeolite particles may have a specific surface area of at least 200 meters squared per gram (m²/g), such as at least 250 m²/g, at least 300 m²/g, at least 350 m²/g, at least 400 m²/g, at least 450 m²/g, at least 500 m²/g, from 200 m²/g to 800 m²/g, from 200 m²/g to 700 m²/g, from 250 m²/g to 800 m²/g, from 250 m²/g to 700 m²/g, from 300 m²/g to 800 m²/g, from 300 m²/g to 700 m²/g, from 350 m²/g to 800 m²/g, from 350 m²/g to 700 m²/g, from 400 m²/g to 800 m²/g, from 400 m²/g to 700 m²/g, from 500 m²/g to 800 m²/g, or any range or subrange of these values. The specific surface area refers to the BET surface area as determined using the Brunauer-Emmett-Teller (BET) method of surface area analysis based on gas adsorption and analysis of gas adsorption isotherms. In embodiments, the zeolite-Y particles may have a total pore volume of from 0.4 cm³/g to 0.7 cm³/g, such as from 0.4 cm³/g to 0.45 cm³/g, from 0.45 cm³/g to 0.5 cm³/g, from 0.5 cm³/g to 0.55 cm³/g, from 0.55 cm³/g to 0.6 cm³/g, from 0.6 cm³/g to 0.65 cm³/g, from 0.65 cm³/g to 0.7 cm³/g, or any combination of one or more of these ranges. The total pore volume can be determined through nitrogen physisorption and analysis of nitrogen physisorption isotherms, which is a well-known method. The unit cell size of the Y-zeolite may be from about 24 Angstrom to about 25 Angstrom, such as 24.56 Angstrom, as determined according to the standard test method in ASTM D3942. In embodiments, the Y-zeolite particles may have a density of from 0.6 g/cm³ to 0.9 g/cm³, as determined according to the standard test method in ASTM D-4052. In embodiments, the Y-zeolite particles may have a weight ratio of silica to alumina of from 5 to 80, such as from 5 to 70, from 5 to 60, from 5 to 50, from 5 to 40, from 5 to 30, from 5 to 20, from 5 to 10, from 10 to 80, from 10 to 70, from 10 to 60, from 10 to 50, from 10 to 40, from 10 to 30, from 10 to 20, from 20 to 80, from 20 to 70, from 20 to 60, from 20 to 50, from 20 to 40, from 20 to 30, from 30 to 80, from 30 to 70, from 30 to 60, from 30 to 50, from 30 to 40, from 40 to 80, from 40 to 70, from 40 to 60, from 40 to 50, from 50 to 80, from 50 to 70, from 50 to 60, from 60 to 80, from 60 to 70, or from 70 to 80.

In embodiments, the Y-zeolite particles can be in the form of shaped microparticles, such as microspheres. As used in the present disclosure, the term “microparticles” refers to particles having an average particle size of from 0.1 microns and 100 microns. The size of a microparticle refers to the maximum length of a particle from one side to another, measured along the longest distance of the microparticle. For instance, a spherically shaped microparticle has a size equal to its diameter, or a rectangular prism shaped microparticle has a maximum length equal to the hypotenuse stretching from opposite corners.

The cracking catalyst composition 124 further comprises the cracking additive, which may include a ZSM-5 zeolite. The ZSM-5 zeolite in the cracking catalyst composition 124 may be operable to crack at least a portion of the crude oil feed 102, to produce one or more light olefins, such as ethylene and propylene. Without being bound by any particular theory, it is believed that the ZSM-5 zeolite may have a greater propensity to crack the relatively lighter hydrocarbons, such as those present in the crude oil feed 102 and those produced by the catalytic cracking of heavier hydrocarbons by the Y-type zeolite. As a result, the inclusion of the ZSM-5 zeolite may increase the yield of products, such as light olefins, when compared to cracking catalysts that do not include the ZSM-5 zeolite, especially when included in conjunction with Y-zeolite.

As used in the present disclosure, “ZSM-5” refers to zeolites having an MFI framework type according to the IUPAC zeolite nomenclature and consisting of silica and alumina. ZSM-5 refers to “Zeolite Socony Mobil-5” and is a pentasil family zeolite that can be represented by the chemical formula NaₙAlₙSi₉₆₋ₙO₁₉₂·16H₂O, where 0<n<27. The molar ratio of silica to alumina in the ZSM-5 zeolite may be at least 5, at least 10, at least 25, at least 30, or at least 50. The molar ratio of silica to alumina in the ZSM-5 zeolite may be less than 80. In embodiments, the molar ratio of silica to alumina in the ZSM-5 zeolite may be from 5 to 80, from 5 to 65, from 5 to 50, from 5 to 40, from 5 to 35, from 10 to 80, from 10 to 65, from 10 to 50, from 10 to 40, from 10 to 35, from 20 to 80, from 20 to 65, from 20 to 50, from 20 to 40, from 20 to 35, from 30 to 80, from 30 to 65, from 30 to 50, or from 30 to 40.

In embodiments, the ZSM-5 zeolite may have a specific surface area from 200 meters squared per gram (m²/g) to 800 m²/g. In embodiments, the specific surface area of the ZSM-5 zeolite may be from 200 m²/g to 400 m²/g, from 200 m²/g to 600 m²/g, from 200 m²/g to 800 m²/g, from 300 m²/g to 400 m²/g, from 300 m²/g to 600 m²/g, from 300 m²/g to 800 m²/g, from 400 m²/g to 600 m²/g, or from 400 m²/g to 800 m²/g. The specific surface area refers to the BET surface area as determined using the Brunauer-Emmett-Teller (BET) method of surface area analysis based on gas adsorption and analysis of gas adsorption isotherms. In embodiments, the ZSM-5 zeolite, can have a total pore volume per unit weight of the ZSM-5 zeolite of from 0.010 cubic centimeters per gram (cm³/g) to 0.500 cm³/g, such as from 0.050 cm³/g to 0.500 cm³/g, from 0.010 cm³/g to 0.300 cm³/g, or from 0.050 cm³/g to 0.300 cm³/g, as determined through nitrogen physisorption and analysis of nitrogen physisorption isotherms, which is a well-known method.

The cracking additive particles may be composite particles, which may comprise the ZSM-5 zeolite particles, a matrix material, and a binder. In embodiments, the cracking additive particles may also include aluminum phosphate. The matrix material may be a clay, such as but not limited to kaolin clay. The binder may be an alumina binder, silica binder, or a combination of alumina and silica binders. In embodiments, the cracking additive may comprise, consist of, or consist essentially of from 50 wt. % to 70 wt. % of the ZSM-5 zeolite particles; from 25 wt. % to 50 wt. % of the matrix material, where the matrix material is kaolin clay; from 10 wt. % to 25 wt. % aluminum phosphate; from 2.5 wt. % to 10 wt. % alumina binder; and less than 1 wt. % silica. In embodiments, the cracking additive may be OLEFINSULTRA® MZ cracking additive from Grace GMBH of Worms, Germany. Suitable commercially available cracking additives may also include, but are not limited to, OLEFINMAX® cracking additive commercially available from Grace GMBH, and NAPHTHAMAX® cracking catalyst commercially available from BASF. Other FCC catalysts commercially available from Albemarle, Zeolyst, JGC C&C and other companies may also be suitable for use as the cracking additive.

The cracking additive may have a density of about 1 g/cm³. In embodiments, the cracking additive particles can be in the form of shaped microparticles, such as microspheres having an average particle size of from 0.1 microns to 100 microns.

In embodiments, the cracking catalyst composition may comprise at least 60 wt. % of the Y-zeolite particles, based on the total weight of the cracking catalyst composition 124. In embodiments, the cracking catalyst composition 124 may comprise at least 65 wt. %, at least 70 wt. %, or at least 75 wt. % of the Y-zeolite particles based on the total weight of the cracking catalyst composition 124. In embodiments, the cracking catalyst composition 124 can include from 60 wt. % to 100 wt. %, from 60 wt. % to 90 wt. %, from 60 wt. % to 80 wt. %, from 60 wt. % to 75 wt. %, 65 wt. % to 100 wt. %, from 65 wt. % to 80 wt. %, from 65 wt. % to 75 wt. %, from 70 wt. % to 100 wt. %, 70 wt. % to 90 wt. %, from 70 wt. % to 80 wt. %, from 70 wt. % to 75 wt. %, from 75 wt. % to 100 wt. %, from 75 wt. % to 90 wt. %, or from 75 wt. % to 80 wt. % of the Y-zeolite particles based on the total weight of the cracking catalyst composition 124.

In embodiments, the cracking catalyst composition 124 can include up to 40 wt. % of the cracking additive particles based on the total weight of the cracking catalyst composition 124. In embodiments, the cracking catalyst composition can include up to 30 wt. %, up to 25 wt. %, or up to 20 wt. % of the cracking additive particles based on the total weight of the cracking catalyst composition 124. In embodiments, the cracking catalyst composition 124 can include from 1 wt. % to 40 wt. %, from 1 wt. % to 30 wt. %, from 1 wt. % to 25 wt. %, from 1 wt. % to 20 wt. %, 5 wt. % to 40 wt. %, from 5 wt. % to 30 wt. %, from 5 wt. % to 25 wt. %, from 5 wt. % to 20 wt. %, 10 wt. % to 40 wt. %, from 10 wt. % to 30 wt. %, from 10 wt. % to 25 wt. %, from 10 wt. % to 20 wt. %, from 15 wt. % to 40 wt. %, from 15 wt. % to 30 wt. %, from 15 wt. % to 25 wt. %, or from 15 wt. % to 20 wt. % of the cracking additive particles based on the total weight of the cracking catalyst composition 124.

The cracking catalyst composition 124 can be formed by mixing the Y-zeolite particles and the cracking additive particles together to form a catalyst blend. In embodiments, microparticles can be mixed, where the microparticles contain only a portion of the cracking catalyst composition 124. For instance, a mixture of two microparticle types may be included in the cracking catalyst composition 124, where one type of microparticle includes only the cracking additive, and another type of microparticle includes only the Y-zeolite.

The cracking catalyst composition 124 can be contacted with steam prior to use in the HS-FCC system 100. The purpose of steam treatment can be to accelerate the hydrothermal aging of the cracking catalyst composition 124 that occurs during operation of the HS-FCC system 100 to obtain an equilibrium catalyst. Not intending to be bound by any particular theory, it is believed that the steam treatment can lead to the removal of aluminum from the framework leading to a decrease in the number of sites where framework hydrolysis can occur under hydrothermal and thermal conditions. This removal of aluminum results in an increased thermal and hydrothermal stability in dealuminated zeolites. The unit cell size can decrease as a result of dealumination, since the smaller SiO₄ tetrahedron replaces the larger AlO₄⁻ tetrahedron. The acidity of zeolites can also be affected by dealumination through the removal of framework aluminum and the formation of extra-framework aluminum species. Dealumination may affect the acidity of the zeolites by decreasing the total acidity and increasing the acid strength of the zeolite. The total acidity can decrease because of the removal of framework aluminum, which act as Brønsted acid sites. The acid strength of the zeolite may be increased because of the removal of paired acid sites or the removal of the second coordinate next nearest neighbor aluminum. The increase in the acid strength may be caused by the charge density on the proton of the OH group being highest when there is no framework aluminum in the second coordination sphere. In embodiments, the cracking catalyst composition 124 can be contacted with steam at a temperature greater than or equal to 800° C. for a period of 6 hours or greater prior to contacting the crude oil feed 102 with the cracking catalyst composition 124 in the HS-FCC system 100.

Referring again to FIG. 1, the HS-FCC system 100 includes the FCC reactor 120 and the regenerator 140. In embodiments, the HS-FCC system 100 can include a plurality of FCC reactors 120, which can be operated in series, in parallel, or a combination of both. The FCC reactor 120 can include a catalyst-feed mixing zone 128, a cracking reaction zone 122, a catalyst separation zone 130, and a stripping zone 132. In embodiments, the cracking reaction zone 122 can be a downflow or “downer” reactor in which the reactants flow from the catalyst-feed mixing zone 128 downward through the cracking reaction zone 122 to the separation zone 130. Steam 127 can be introduced to the top portion of the cracking reaction zone 122 to provide additional heating to the mixture of the crude oil feed 102 and the cracking catalyst composition 124. The separation zone 130 may include one or a plurality of fluid-solid separation units, disposed at an outlet of the FCC reactor 120, operable to separate the cracked effluent 126 from the used cracking catalyst 125. Steam 133 can be introduced to the bottom portion of the stripping zone 132 to facilitate stripping the cracked effluent 126 from the used cracking catalyst 125. The cracked effluent 126 can exit the separation zone 130, and the stripped effluent can exit the stripping zone 132.

It should be understood that the cracking reaction zone 122 of the FCC reactor 120 depicted in FIG. 1 is a simplified schematic of one particular embodiment of the cracking reaction zone 122 of an FCC reactor, and other configurations of the cracking reaction zone 122 may be suitable for incorporation into the HS-FCC system 100. In embodiments, the cracking reaction zone 122 can be an up-flow cracking reaction zone. In embodiments, the cracking reaction zone 122 can include one or more riser reactors. Other embodiments may include two or more FCC reactors operating in parallel under similar or different operating conditions.

Referring again to FIG. 1, the FCC reactor 120 is fluidly coupled to the regenerator 140. In embodiments, the regenerator 140 can be a single-zone regenerator that includes a regeneration zone 142. The used cracking catalyst 125 can be regenerated in the regeneration zone 142 to produce a regenerated cracking catalyst 123. In other embodiments, the regenerator 140 can be a dual-zone regenerator that includes two separate regeneration zones (not pictured). Referring again to FIG. 1, the regenerator 140 can include a riser 144. The riser 144 can be positioned between the stripping zone 132 and the regeneration zone 142. The used cracking catalyst 125 is regenerated to produce the regenerated cracking catalyst 123. The regenerated cracking catalyst 123 is then passed back to the catalyst-feed mixing zone 128 as the cracking catalyst composition 124.

The HS-FCC system 100 can include a catalyst hopper 148 disposed between the regeneration zone 142 of the regenerator 140 and the FCC reactor 120. The regenerated cracking catalyst 123 can be passed from the regeneration zone 142 to the catalyst hopper 148, where the regenerated cracking catalyst 123 can accumulate prior to passing from the catalyst hopper 148 to the catalyst-feed mixing zone 128 as the cracking catalyst composition 124. The regenerated cracking catalyst 123, which may be at an elevated temperature equal to or greater than the reaction temperature in the cracking reaction zone 122, can provide heat for the endothermic cracking reaction in the cracking reaction zone 122.

During operation of the HS-FCC system 100, the crude oil feed 102 can be introduced to the catalyst-feed mixing zone 128, where the crude oil feed 102 can be mixed with the cracking catalyst composition 124. The mixture comprising the crude oil feed 102 and the cracking catalyst composition 124 can be introduced to the cracking reaction zone 122. When the cracking reaction zone 122 is a downflow reactor, the mixture of the crude oil feed 102 and the cracking catalyst composition 124 can be introduced to a top portion of the cracking reaction zone 122. When the cracking reaction zone 122 is an upflow reactor, the mixture of the crude oil feed 102 and the cracking catalyst composition 124 can be introduced to a bottom of a riser portion of the cracking reaction zone 122, and may be combined with a carrier gas (not shown).

During steady state operation of the HS-FCC system 100, the cracking catalyst composition 124 can be the regenerated cracking catalyst 123 that is passed to the catalyst-feed mixing zone 128 from the catalyst hopper 148. The catalyst hopper 148 can receive the regenerated cracking catalyst 123 from the regenerator 140 following regeneration of the used cracking catalyst 125. At initial start-up of the HS-FCC system 100, the FCC catalyst composition 124 can include fresh FCC catalyst (not shown), which may be the cracking catalyst composition 124 particles that have not been circulated through the FCC reactor 120 and the regenerator 140. Fresh cracking catalyst composition 124 can be introduced to the catalyst hopper 148 periodically during operation to replenish lost cracking catalyst composition 124 microparticles or compensate for used cracking catalyst 125 that becomes permanently deactivated, such as through heavy metal accumulation in the catalyst.

Hydrocarbons from the crude oil feed 102 are contacted with the cracking catalyst composition 124 in the cracking reaction zone 122, which causes at least a portion of the hydrocarbons from the crude oil feed 102 to undergo one or more catalytic cracking reactions to form one or more cracking reaction products, which can include light olefins, light aromatic compounds, or both. The cracking catalyst composition 124 can have a temperature equal to or greater than the reaction temperature of the cracking reaction zone 122 and can transfer heat to the crude oil feed 102 to promote the endothermic cracking reaction. Steam 127 can be added to the cracking reaction zone 122 to further increase the temperature in the cracking reaction zone 122, increase the surface area of the crude oil feed 102 by atomizing the crude oil feed 102 into smaller droplets, or reduce the hydrocarbon partial pressure, all of which can improve production of light olefins compared to not injecting steam into the cracking reaction zone 122.

In embodiments, the FCC reactor 120 can be operated under high-severity reaction conditions. In embodiments, the cracking reaction zone 122 can be operated at a reaction temperature of from 580° C. to 750° C. In embodiments, the reaction temperature of the cracking reaction zone 122 can be from 580° C. to 740° C., from 580° C. to 720° C., from 580° C. to 700° C., from 580° C. to 680° C., from 580° C. to 660° C., from 580° C. to 650° C., from 600° C. to 750° C., from 600° C. to 740° C., from 600° C. to 720° C., from 600° C. to 700° C., from 600° C. to 680° C., from 600° C. to 660° C., from 600° C. to 650° C., from 620° C. to 750° C., from 620° C. to 740° C., from 620° C. to 720° C., from 620° C. to 700° C., from 620° C. to 680° C., from 620° C. to 660° C., or from 620° C. to 650° C. When the reaction temperature of the cracking reaction zone 122 is greater than, for instance, 750° C., the crude oil feed 102 may undergo increased thermal cracking and decreased catalytic cracking compared to embodiments where the reaction temperature of the cracking reaction zone 122 is less than 750° C. Thermal cracking of the crude oil feed 102 can increase yield of ethylene and propylene and decrease yield of other products. In embodiments, the crude oil feed 102 can be contacted with the cracking catalyst composition 124 in the FCC reactor 120 at a temperature of from 600° C. to 650° C. Catalytic cracking of the crude oil feed 102 in the FCC reactor 120 can yield a greater number of desired products, such as light olefins and aromatics.

In embodiments, the FCC reactor 120 can be operated with a catalyst-to-oil (CTO) weight ratio from 1 to 60, where the catalyst-to-oil weight ratio is the weight ratio of the cracking catalyst composition 124 to the weight of the crude oil feed 102 in a unit volume of the reaction mixture comprising the crude oil feed 102 and the cracking catalyst composition 124. In embodiments, the FCC reactor 120 can be operated with a catalyst-to-oil weight ratio from 1 to 3, from 1 to 5, from 1 to 10, from 1 to 15, from 1 to 30, from 1 to 60, from 2 to 3, from 2 to 5, from 2 to 10, from 2 to 15, from 2 to 30, from 2 to 60, from 3 to 5, from 3 to 10, from 3 to 15, from 3 to 30, from 3 to 60, from 5 to 10, from 5 to 15, from 5 to 30, from 5 to 60, from 10 to 15, from 10 to 30, from 10 to 60, from 15 to 30, from 15 to 60, or from 30 to 60. Without intending to be bound by any particular theory, it is believed that a catalyst-to-oil weight ratio less than 1 may not provide a sufficient amount of catalyst present to catalytically crack the crude oil feed 102 at an economically high yield. It is believed that a catalyst-to-oil weight ratio greater than 60 may not be economically practical for scaling up in commercial applications.

In embodiments, the FCC reactor 120 can be operated with a contact time from 0.1 seconds to 60 seconds. In embodiments, the FCC reactor 120 may be operated with a contact time from 0.1 seconds to 30 seconds, from 0.1 seconds to 60 seconds, from 20 seconds to 40 seconds, or from 30 seconds to 60 seconds. Without intending to be bound by any particular theory, it is believed that a contact time less than 0.1 seconds may not provide sufficient time for hydrocarbons in the crude oil feed 102 to be sufficiently cracked by the cracking catalyst composition 124.

Catalytically cracking the crude oil feed 102 through contact with the cracking catalyst composition 124 produces a mixture of the used cracking catalyst 125 and a cracked effluent 126. The used cracking catalyst 125 may be separated from the cracked effluent 126 and passed to the regeneration zone 142 of the regenerator 140, in which the used cracking catalyst 125 is regenerated to produce the regenerated cracking catalyst 123. The regenerated cracking catalyst 123 is then passed back to the cracking reaction zone 122 as the cracking catalyst composition 124.

Following the cracking reaction in the cracking reaction zone 122, the contents of the cracking reaction zone 122 include the used cracking catalyst 125 and the cracked effluent 126, which may then be passed to the separation zone 130. In the separation zone 130, the used cracking catalyst 125 can be separated from at least a portion of the cracked effluent 126. In embodiments, the separation zone 130 can include one or more fluid-solid separators, such as one or more cyclones. The used cracking catalyst 125 exiting from the separation zone 130 can retain at least a portion of the cracked effluent 126, such as cracked effluent 126 retained in the pores of the used cracking catalyst 125, between microparticles of the used cracking catalyst 125, or both.

Following separation from the cracked effluent 126 in the separation zone 130, the used cracking catalyst 125, which may include at least a portion of the cracked effluent 126 retained in the used cracking catalyst 125, can be passed to the stripping zone 132, where the additional portions of the cracked effluent 126 are stripped from the used cracking catalyst 125 and recovered as a stripped effluent 134. The stripped effluent 134 can be passed to one or more downstream unit operations or combined with the cracked effluent 126 for further processing. Steam 133 may be introduced to the stripping zone 132 to facilitate stripping the retained portions of the cracked effluent 126 from the used cracking catalyst 125. The stripped effluent 134, which may include at least a portion of the steam 133 introduced to the stripping zone 132, can be discharged from the stripping zone 132, at which point stripped effluent 134 can pass through cyclone separators (not shown) and out of the stripper vessel (not shown). The stripped effluent 134 can be directed to one or more product recovery systems in accordance with known methods in the art. The stripped effluent 134 may also be combined with one or more other streams, such as the cracked effluent 126. The used cracking catalyst 125, after having been stripped of at least a portion of the retained portions of the cracked effluent 126, can be then passed to the regeneration zone 142 of the regenerator 140.

The used cracking catalyst 125 and a combustion gas 146 can be introduced to a bottom end of the riser 144 of the regenerator 140. The combustion gases 146 can include one or more of combustion air, oxygen, fuel gas, fuel oil, or combinations of these. The combustion gases 146 can convey the used cracking catalyst 125 upwards through the riser 144 to the regeneration zone 142, where coke deposits and residual reactants and reaction products are at least partially oxidized (combusted). The coke deposited on the used cracking catalyst 125 in the cracking reaction zone 122 may begin to oxidize in the presence of the combustion gases 146 in the riser 144 on the way upward to the regeneration zone 142. The used cracking catalyst 125 is regenerated to produce a regenerated cracking catalyst 123. During regeneration, the coke deposits on the used cracking catalyst 125 are removed and the catalyst particles are heated through combustion of the coke deposits, an additional fuel gas, or combinations of these to produce the regenerated cracking catalyst 123. The regenerated cracking catalyst 123 is then passed back to the cracking reaction zone 122 as the cracking catalyst composition 124.

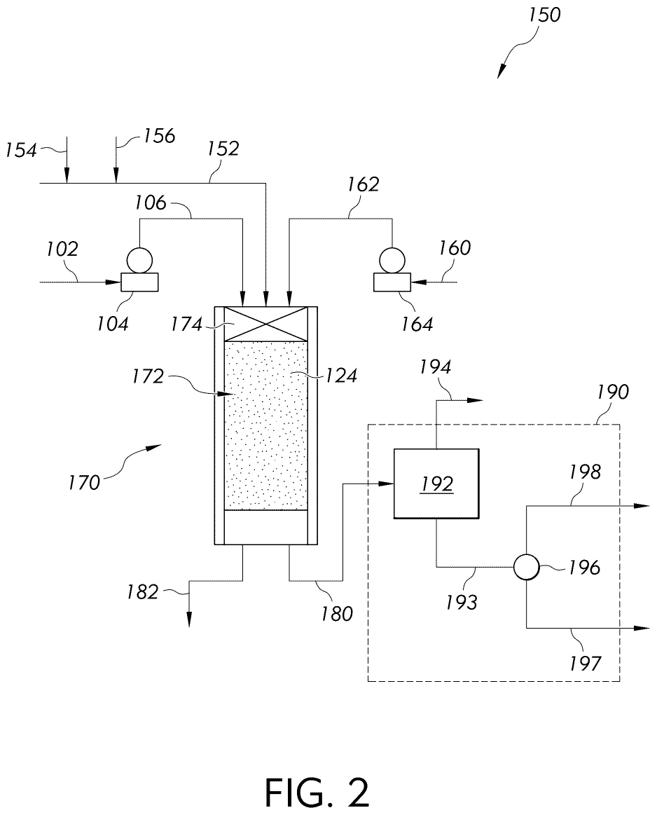

Referring now to FIG. 2, one embodiment of a fixed bed cracking system 150 for catalytic cracking the crude oil feed 102 is schematically depicted. The fixed bed cracking system 150 may include at least one fixed bed reactor 170. The fixed bed reactor 170 may include one or a plurality of fixed bed reactors operated in series or in parallel. In embodiments, the fixed bed reactor 170 may include a plurality of fixed bed reactors in parallel and operated in a swing mode. The fixed bed reactor 170 may operate to contact the crude oil feed 102 with steam in the presence of the cracking catalyst composition 124 of the present disclosure to produce a cracking effluent comprising light olefins, aromatic compounds, or combinations of these. The fixed bed reactor 170 may include the cracking catalyst composition 124 disposed within a catalytic cracking zone 172. The cracking catalyst composition 124 in the fixed bed reactor 170 may have any of the compositions, properties, or other features previously described in the present disclosure for the cracking catalyst composition 124. The fixed bed reactor 170 may further include a porous packing material 174, such as silica carbide packing, upstream of the catalytic cracking zone 172. The porous packing material 174 may ensure sufficient heat transfer to the crude oil feed 102 and steam prior to conducting the catalytic cracking reaction in the catalytic cracking zone 172.

Referring again to FIG. 2, the crude oil feed 102 may be introduced to the fixed bed reactor 170. The crude oil feed 102 may have any of the compositions, properties, or other features disclosed in the present disclosure for the crude oil feed 102. In embodiments, the crude oil feed 102 may be introduced directly to the fixed bed cracking system 150, such as by passing the crude oil feed 102 to the fixed bed reactor 170 without passing the crude oil feed 102 to any separation system or unit operation that changes the hydrocarbon composition of the crude oil feed 102.

Introducing the crude oil feed 102 to the fixed bed reactor 170 may include heating the crude oil feed 102 to a temperature of from 35° C. to 150° C. and then passing the crude oil feed 102 to the fixed bed reactor 170. In embodiments, the crude oil feed 102 may be pre-heated to a temperature of from 40° C. to 150° C., from 45° C. to 150° C., from 50° C. to 150° C., from 35° C. to 145° C., from 40° C. to 145° C., from 45° C. to 145° C., from 35° C. to 140° C., from 40° C. to 140° C., or from 45° C. to 140° C. In embodiments, passing the crude oil feed 102 to the fixed bed reactor 170 may include passing the crude oil feed 102 to a feed pump 104 that increases the pressure of the crude oil feed 102 and conveys the crude oil feed 102 to the fixed bed reactor 170. The flowrate of the feed pump 104 may be adjusted so that the crude oil feed 102 is injected into the fixed bed reactor 170 at a gas hourly space velocity of greater than or equal to 0.1 per hour (h⁻¹) or greater than or equal to 0.25 h⁻¹. The crude oil feed 102 may be injected into the fixed bed reactor 170 at a gas hourly space velocity of less than or equal to 50 h⁻¹, less than or equal to 25 h⁻¹, less than or equal to 20 h⁻¹, less than or equal to 14 h⁻¹, less than or equal to 9 h⁻¹, or less than or equal to 5 h⁻¹. The crude oil feed 102 may be injected into the fixed bed reactor 170 via feed inlet line 106. The crude oil feed 102 may be further pre-heated in the feed inlet line 106 to a temperature of from 100° C. to 250° C. before injecting the crude oil feed 102 into the fixed bed reactor 170.

Referring again to FIG. 2, the fixed bed reactor 170 may be configured to introduce steam to the catalytic cracking zone 172. In embodiments, water 160 may be injected into the fixed bed reactor 170 through water feed line 162 via the water feed pump 164. The water feed line 162 may be pre-heated to heat the water 160 to a temperature of from 50° C. to 175° C., from 50° C. to 150° C., from 60° C. to 175° C., or from 60° C. to 170° C. The water 160 may be converted to steam in water feed line 162 or upon contact with the crude oil feed 102 in the fixed bed reactor 170. The flowrate of the water feed pump 164 may be adjusted to deliver the water 160 (liquid, steam, or both) to the fixed bed reactor 170 at a gas hourly space velocity (GHSV) of greater than or equal to 0.1 per hour (h⁻¹), greater than or equal to 0.5 h⁻¹, greater than or equal to 1 h⁻¹, greater than or equal to 5 h⁻¹, greater than or equal to 10 h⁻¹, or even greater than or equal to 15 h⁻¹. The water 160 may be introduced to the fixed bed reactor 170 at a GHSV of less than or equal to 100 h⁻¹, less than or equal to 75 h⁻¹, less than or equal to 50 h⁻¹, less than or equal to 30 h⁻¹, or less than or equal to 20 h⁻¹.

The steam produced from injection of the water 160 into the fixed bed reactor 170 may reduce the hydrocarbon partial pressure, which may have the dual effects of increasing yields of light olefins (e.g., ethylene, propylene and butylene) as well as reducing coke formation on the cracking catalyst. Not intending to be limited by any particular theory, it is believed that light olefins like propylene and mixed butenes are mainly generated from catalytic cracking reactions following the carbonium ion mechanism, and as these are intermediate products, they can undergo secondary reactions such as hydrogen transfer and aromatization (leading to coke formation). The steam may increase the yield of light olefins by suppressing these secondary bi-molecular reactions, and may reduce the concentration of reactants and products, which favor selectivity towards light olefins. The steam may also suppress secondary reactions that are responsible for coke formation on the catalyst surface, which is good for catalysts to maintain high average activation. These factors may show that a large steam-to-oil weight ratio may be beneficial to the production of light olefins.

The mass flow rate of the water 160 to the fixed bed reactor 170 may be less than the mass flow rate of the crude oil feed 102 to the fixed bed reactor 170. In embodiments, a mass flow ratio of the water 160 (steam) to the crude oil feed 102 introduced to the fixed bed reactor 170 can be less than 1, such as from 0.2 to less than 1, from 0.2 to 0.9, from 0.2 to 0.8, from 0.2 to 0.7, from 0.2 to 0.6, from 0.3 to less than 1, from 0.3 to 0.9, from 0.3 to 0.8, from 0.3 to 0.7, from 0.3 to 0.6, from 0.4 to less than 1, from 0.4 to 0.9, from 0.4 to 0.8, from 0.4 to 0.7, from 0.4 to 0.6, from 0.5 to less than 1, from 0.5 to 0.9, from 0.5 to 0.8, from 0.5 to 0.7, from 0.5 to 0.6. In embodiments, the mass flow ratio of the water 160 to the crude oil feed 102 introduced to the fixed bed reactor 130 can be about 0.5. The water may be present as steam in the fixed bed reactor 130.

Referring again to FIG. 2, the fixed bed cracking system 150 may be operable to contact the crude oil feed 102 with the cracking catalyst composition 124, with or without steam, in the fixed bed reactor 170 under reaction conditions sufficient to cause at least a portion of the hydrocarbons from the crude oil feed 102 to undergo one or more cracking reactions to produce a cracking effluent 180 comprising light olefins, light aromatic compounds, or both. In embodiments, the cracking effluent 180 may comprise light olefins, which may include but are not limited to ethylene, propylene, mixed butenes, or combinations of these. In embodiments, the cracking effluent 180 may comprise light aromatic compounds, which refers to compounds containing an aromatic ring structure and having less than or equal to 10 carbon atoms. The light aromatic compounds in the cracking effluent 180 may include but are not limited to benzene, toluene, ethylbenzene, mixed xylenes, or other light aromatic compounds.

The fixed bed reactor 170 may be operated at a temperature of greater than or equal to 525° C., such as temperatures of from 525° C. to 800° C., from 525° C. to 750° C., from 525° C. to 700° C., from 525° C. to 675° C., from 550° C. to 750° C., from 550° C. to 700° C., from 550° C. to 675° C., from 575° C. to 750° C., from 575° C. to 700° C., from 575° C. to 675° C., from 600° C. to 750° C., from 600° C. to 700° C., from 600° C. to 675° C., from 600° C. to 650° C., from 625° C. to 700° C., or from 625° C. to 675° C. The fixed bed reactor 170 may be configured to operate at a pressure of from about 100 kilopascals (kPa) (1 bar) to 1000 kPa (10 bar), or about atmospheric pressure (approximately from 1 to 2 bar (100 kPa to 200 kPa)).

The methods of the present disclosure may include contacting the crude oil feed 102 with the steam (water 160) in the presence of the cracking catalyst composition 124 in the fixed bed reactor 170 for a residence time sufficient to convert at least a portion of the hydrocarbon compounds in the crude oil feed 102 to light olefins, light aromatic compounds, or both. In embodiments, the methods may include contacting the crude oil feed 102 with the steam (water 160) in the presence of the cracking catalyst composition 124 in the fixed bed reactor 170 for a residence time of from 1 second (sec) to 60 sec, such as from 5 sec to 30 sec, or about 10 sec.

In embodiments, the fixed bed reactor 170 may be operated in a semi-continuous manner. For example, during a conversion cycle, the fixed bed reactor 170 may be operated with the crude oil feed 102 and water 160 flowing to the fixed bed reactor 170 for a period of time. After the period of the time, the cracking catalyst composition 124 may be regenerated. Each conversion cycle of the fixed bed reactor 170 may be from 2 to 24 hours, from 2 to 20 hours, from 2 to 16 hours, from 2 to 12 hours, from 2 to 10 hours, from 2 to 8 hours, from 4 to 24 hours, from 4 to 20 hours, from 4 to 16 hours, from 4 to 12 hours, from 4 to 10 hours, from or 4 to 8 hours before switching off the feed pump 104 and the water feed pump 164 to cease the flow of crude oil and steam to the fixed bed reactor 170.

At the end of the conversion cycle, the flow of crude oil feed 102 and water 160 may be stopped and the cracking catalyst composition 124 may be regenerated in a regeneration cycle. In embodiments, the fixed bed cracking system 150 may include a plurality of fixed bed reactors 170, which may be operated in parallel or in series. In embodiments, the fixed bed cracking system 150 may include 2, 3, 4, 5, 6, or more than 6 of the fixed bed reactors 170, which may be operated in series or in parallel. With a plurality of the fixed bed reactors 170 operating in parallel, one or more of the fixed bed reactors 170 can continue in a conversion cycle while one or more of the other fixed bed reactors 170 are taken off-line for regeneration of the cracking catalyst composition 124, thus maintaining continuous operation of the fixed bed cracking system 150.

Referring again to FIG. 2, during a regeneration cycle, the fixed bed reactor 170 may be operated to regenerate the cracking catalyst composition 124 to remove coke deposits accumulated during the conversion cycle. To regenerate the cracking catalyst composition 124, hydrocarbon gas and liquid products produced by the catalytic cracking process may be evacuated from the fixed bed reactor 170. Nitrogen gas 154 may be introduced to the fixed bed reactor 170 through gas inlet line 152 to evacuate the hydrocarbon gas and liquid products from the fixed bed reactor 170. The nitrogen gas 154 may be introduced to the fixed bed reactor 170 at gas hourly space velocity of from 10 per hour (h⁻¹) to 100 h⁻¹.

Following evacuation of the hydrocarbon gases and liquids, air 156 may be introduced to the fixed bed reactor 170 through the gas inlet line 152 at a gas hourly space velocity of from 10 h⁻¹ to 100 h⁻¹. The nitrogen and/or air may be passed out of the fixed bed reactor 170 through gas outlet line 182. While passing air 156 through the cracking catalyst composition 124 in the fixed bed reactor 170, the temperature of the fixed bed reactor 170 may be adjusted from the reaction temperature to a regeneration temperature of from 650° C. to 750° C. for a period of from 3 hours to 5 hours. The gas produced by air regeneration of the cracking catalyst composition 124 may be passed out of the fixed bed reactor 170 and may be analyzed by an in-line gas analyzer to detect the presence or concentration of carbon dioxide produced through de-coking of the cracking catalyst composition 124. Once the carbon dioxide concentration in the gases passing out of the fixed bed reactor 170 is reduced to less than 0.05% to 0.1% by weight, as determined by the in-line gas analyzer, the temperature of the fixed bed reactor 170 may be decreased from the regeneration temperature back to the reaction temperature. The air flow through gas inlet line 152 may be stopped. Nitrogen gas may be passed through the cracking catalyst composition 124 for 15 to 30 minutes to remove air from the fixed bed reactor 170. Following treatment with nitrogen, the flows of the crude oil feed 102 and water 160 may be resumed to begin another conversion cycle of fixed bed reactor 170.

Referring again to FIG. 2, the cracking effluent 180 may pass out of the fixed bed reactor 170. The cracking effluent 180 may include one or more products and intermediates, such as but not limited to light hydrocarbon gases, light olefins, aromatic compounds, pyrolysis oil, or combinations of these. The light olefins in the cracking effluent 180 may include ethylene, propylene, butenes, or combinations of these.

Referring again to FIG. 2, the fixed bed cracking system 150 may further include a cracking effluent separation system 190 disposed downstream of the fixed bed reactor 170. The cracking effluent separation system 190 may separate the cracking effluent 180 into one or more than one cracking product effluents, which may be liquid or gaseous product effluents. The cracking effluent separation system 190 may include one or a plurality of separation units. Separation units may include but are not limited to distillation columns, fractionators, flash drums, knock-out drums, knock-out pots, centrifuges, decanters, filtration devices, traps, scrubbers, expansion devices, membranes, solvent extraction devices, adsorption devices, chemical separators, crystallizers, chromatographs, precipitators, evaporators, driers, high-pressure separators, low-pressure separators, or combinations or these. The separation units may include one or more gas-liquid separators, one or more liquid-liquid separators, or a combination of these.

In embodiments, the cracking effluent separation system 190 may include a gas-liquid separation unit 192 and a centrifuge unit 196 downstream of the gas-liquid separation unit 192. The gas-liquid separation unit 192 may operate to separate the cracking effluent 180 into a liquid effluent 193 and a gaseous effluent 194. The gaseous effluent 194 may include olefins, such as ethylene, propylene, butenes, or combinations of these; light hydrocarbon gases, such as methane, ethane, propane, n-butane, i-butane, or combinations of these; other gases, such as but not limited to hydrogen; or combinations of these. The gaseous effluent 194 may include the C₂-C₄ olefin products, such as but not limited to, ethylene, propylene, butenes (1-butene, cis-2-butene, trans-2-butene, isobutene, or combinations of these), or combinations of these, produced in the steam catalytic cracking reactor 130.

The liquid effluent 193 may include distillation fractions such as naphtha, kerosene, gas oil, vacuum gas oil; unconverted feedstock; residue; water; or combinations of these. The liquid effluent 193 may include the light aromatic compounds produced in the fixed bed reactor 170, which light aromatic compounds may include but are not limited to benzene, toluene, mixed xylenes, ethylbenzene, and other light aromatic compounds. The liquid effluent 193 may be a two-phase stream comprising an oil phase and an aqueous phase immiscible with the oil phase. In embodiments, the liquid effluent 193 may be passed to the in-line centrifuge unit 196, which may be configured to separate the liquid effluent 193 into a liquid hydrocarbon effluent 197 and an aqueous effluent 198. The liquid hydrocarbon effluent 197 may include hydrocarbons from the cracking effluent 180 having greater than or equal to 5 carbon atoms, which may include the light aromatic compounds produced in the fixed bed reactor 170.

In embodiments, crude oil may be cracked to product light olefins, light aromatics, or both by first passing a crude oil feed to a catalytic cracking system including a cracking reactor. The crude oil feed may be a whole crude oil or a desalted crude oil, and the crude oil feed may comprise hydrocarbons. Then, the crude oil may be contacted with a cracking catalyst composition in the cracking reactor at high-severity reaction conditions. The cracking catalyst composition may be a mixture of Y-zeolite particles and cracking additive particles. The Y-zeolite particles may comprise silicon dioxide, aluminum oxide, iron (III) oxide, titanium (IV) oxide, phosphorous (V) pentoxide, sodium dioxide, and aluminum sulfate. The cracking additive particles may comprise ZSM-5 zeolite particles, aluminum phosphate, calcined Kaolin clay, aluminum oxide, and quartz. Contacting the crude oil with the cracking catalyst composition may cause at least a portion of the hydrocarbons in the crude oil feed to undergo one or more cracking reactions. The cracking reactions may produce a cracking effluent, which may include light olefins, light aromatic compounds, or both, and a used cracking catalyst composition.

### EXAMPLES

The various aspects of the present disclosure will be further clarified by the following examples. The examples are illustrative in nature and should not be understood to limit the subject matter of the present disclosure.

### Catalyst Testing-ACE Testing

In the Examples of the present disclosure, crude oil feeds were catalytically cracked with the cracking catalyst composition of the present disclosure according to an Advanced Cracking Evaluation (ACE) test procedure to show the products produced through catalytically cracking the crude oil with cracking catalyst compositions of the present disclosure. The ACE tests were conducted using ACE testing unit. The ACE testing process is described more in detail in U.S. Pat. No. 6,069,012.

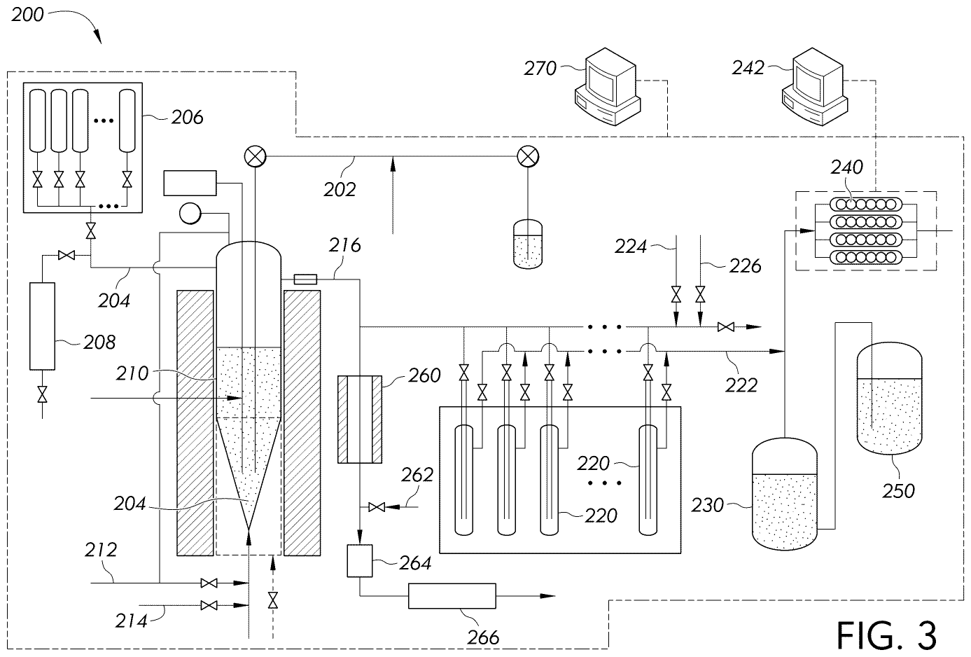

Referring to FIG. 3, the ACE unit 200 used in these examples is schematically depicted. The ACE unit 200 includes a fluidized reactor 210 configured to simulate a reaction in an FCC reactor. Fluidization gas 212 is introduced to the bottom of the fluidized reactor 210 to maintain the catalyst 204 in a fluidized state. The catalyst 204 is loaded into the fluidized reactor 210 from the catalyst hopper 206. The feed 202 (crude oil) is introduced to the top of the fluidized reactor 210 and flows downward into the catalyst 204 fluidized within the fluidized reactor 210. After contacting the feed 202 with the catalyst 204 in the reactor, the reaction effluent 216 is passed out of the fluidized reactor 210 to the product liquid receivers 220, which separate the liquid products from the gaseous products. The gaseous product stream 222 is passed to a product gas receiver 230. The composition of the gaseous product stream 222 is analyzed using a micro gas chromatograph 240 having a GC control unit 242. The catalyst 204 is regenerated by introducing a regeneration gas 214 into the bottom of the fluidized reactor 210. The flue gas is treated in a catalytic converter 260 and passed through a flow meter 262 and CO₂ analyzer 264 for quantifying the amount of coke produced during the reactions. The ACE unit 200 can include an ACE control system 270 for controlling operation of the ACE unit 200.

### Catalyst Testing-MAT Testing

In the Examples of the present disclosure, crude oil feed streams were also catalytically cracked with the cracking catalyst composition of the present disclosure using a micro activity test (MAT) instrument having a quartz reactor. The MAT instrument was obtained from Sakuragi Rikagaku (Japan). The cracking catalyst composition was evaluated for cracking in these examples according to standard test method ASTM D-3907.

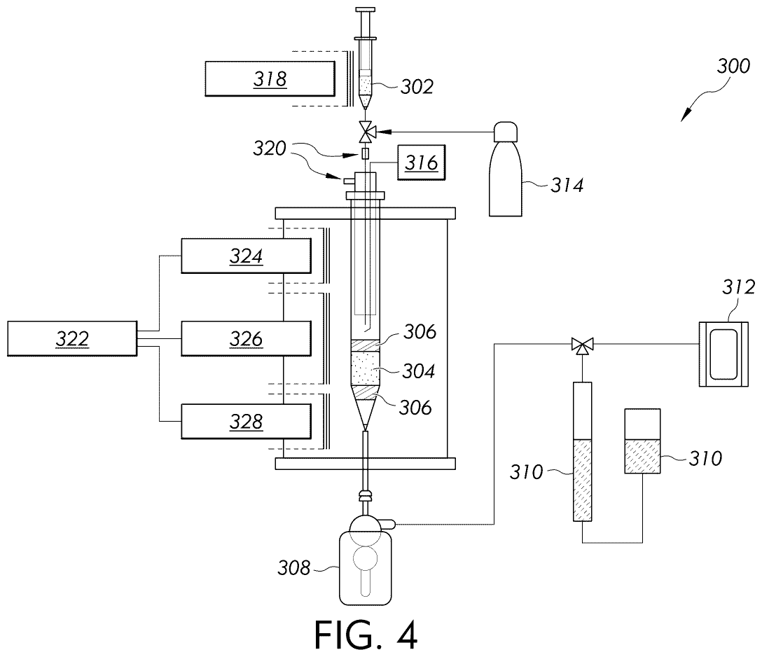

Referring to FIG. 4, the MAT unit 300 used for the MAT testing in these examples is schematically depicted. The MAT unit 300 includes a fixed bed quartz tubular reactor configured to simulate a reaction in a fixed bed reactor. The catalyst 304 is loaded into the fixed bed quartz tubular reactor in between quartz wool 306. The catalyst 304 is steam deactivated at 810° C. for six hours prior to the reaction to mimic the equilibrium catalyst in commercial operation. The catalyst 304 in the fixed bed quartz tubular reactor is heated by the furnace 322, the furnace 322 comprising a top heater 324, a middle heater 326, and a bottom heater 328. The feed 302 is injected in the top of the fixed bed quartz tubular reactor through a feed syringe. The feed 302 can be heated prior to injection with the syringe heater 318. The injection site can be heated prior to injection by the preheator 320. The feed 302 is in contact with the catalyst 304 for thirty seconds per reaction. After contacting the feed 302 with the catalyst 304, the reaction effluent, comprising liquid product and gaseous products, is passed out of the fixed bed quartz tubular reactor. The liquid product created by the reaction is collected in the liquid receiver 308, and the gaseous product created by the reaction is collected in the gas collectors 310 through water displacement. The gaseous product is then analyzed by the gas chromatograph 312. After the reaction, the catalyst 304 is stripped using nitrogen gas 314, which enters the fixed bed quartz tubular reactor at 30 cm³/min.

### Example 1: ACE Testing of AL Crude Oil with the Cracking Catalyst Composition

In Example 1, the performance of a cracking catalyst composition for cracking a light crude oil (AL crude oil) was investigated. In Example 1, the exemplary FCC catalyst composition included 75 wt. % Y-zeolite particles and 25 wt. % cracking additive particles. The Y-zeolite was HSFCC5 cracking catalyst obtained from JGC Catalysts and Chemicals Ltd of Kawasaki City, Japan. The cracking additive particles were OLEFINSULTRA® MZ cracking additive obtained from Grace GMBH of Worms, Germany. The cracking catalyst composition was used to evaluate cracking of AL crude oil under various reaction conditions. The properties and characteristics of the AL crude oil utilized in the examples were previously provided in Table 1. The catalytic cracking of the AL crude oil with the cracking catalyst composition was carried out in an ACE testing unit. The cracking catalyst composition of was evaluated for cracking AL crude oil according to the Advanced Cracking Evaluation (ACE) test procedure. Prior to evaluation, the cracking catalyst composition was heated to 650° C. and 675° C. and fluidized using nitrogen. The experiments were conducted in the ACE unit at 75 seconds time-on-stream (TOS) and a catalyst-to-oil weight ratio of 8.11.

After each reaction, the cracking catalyst composition was stripped using nitrogen (N₂). During the regeneration of the cracking catalyst composition, the gas product was sent to a CO₂ analyzer to determine the amount of coke produced during the reactions.

The ACE results from the cracking of AL crude oil over the cracking catalyst composition are shown in Table 2. As can be seen, high light olefin yields of greater than 38 wt. %, high propylene yields of greater than 17 wt. %, and high light aromatic compound yields of greater than 24 wt. %, were obtained using the exemplary cracking catalyst composition. Reaction conditions of 675° C. achieved the greatest light olefin yield of 40.19 wt. % and the greatest propylene yield of 18.02 wt. % (Ex. 1-2). Reaction conditions of 650° C. achieved the greatest light aromatic compound yield of 26.37 wt. % (Ex. 1-1).

TABLE 2
ACE Data for Cracking AL Crude Oil

| | Ex. 1-1 | Ex. 1-2 |
|---|---|---|
| Temperature (° C.) | 650 | 675 |
| Injection Time (s) | 75 | 75 |
| Catalyst | 75 wt. % Y- | 75 wt. % Y- |
| | zeolite | zeolite |
| | particles, | particles, |
| | 25 wt. % | 25 wt. % |
| | cracking | cracking |
| | additive | additive |
| | particles | particles |
| Steaming conditions | 810° C., 6 h | 810° C., 6 h |
| Feed code | AL Crude | AL Crude |
| catalyst to oil ratio (CTO) | 8.11 | 8.11 |
| Conversion (%) | 85.74 | 87.96 |

Yields (mass %)

| | | |
|---|---|---|
| Hydrogen (H₂) | 0.34 | 0.40 |
| Methane (C₁) | 4.35 | 6.42 |
| Ethane (C₂) | 3.43 | 4.44 |
| Ethylene (C_{2═}) | 12.31 | 14.16 |
| Propane (C₃) | 3.40 | 2.72 |
| Propylene (C_{3═}) | 17.77 | 18.02 |
| Isobutane (iC₄) | 0.66 | 0.38 |
| Normal butane (nC₄) | 0.93 | 0.64 |
| Trans-2-butene (t2C_{4═}) | 2.00 | 1.74 |
| 1-Butene (1C_{4═}) | 1.42 | 1.29 |
| Isobutene (iC_{4═}) | 3.04 | 2.84 |
| Cis-2-butene (c2C_{4═}) | 1.59 | 1.40 |
| 1,3-butadiene | 0.42 | 0.73 |
| Total Gases | 51.65 | 55.20 |
| Gasoline | 26.37 | 24.19 |
| Light cycle oil (LCO) | 10.61 | 8.83 |
| Heavy cycle oil (HCO) | 3.66 | 3.21 |
| Coke | 7.72 | 8.57 |

Groups (mass %)

| | | |
|---|---|---|
| Dry Gas (H₂ − C₂) | 20.43 | 25.43 |
| LPG (C₃ − C₄) | 31.22 | 29.77 |
| Light olefins (C_{2═} − C_{4═}) | 38.55 | 40.19 |
| C_{3═} + C_{4═} | 26.23 | 26.03 |
| Butenes (C_{4═}) | 8.47 | 8.01 |

Molar ratio (mol/mol)

| | | |
|---|---|---|
| C_{2═}/C₂ | 3.85 | 3.42 |
| C_{3═}/C₃ | 5.48 | 6.94 |
| C_{4═}/C₄ | 5.52 | 8.16 |
| iC_{4═}/C_{4═} | 0.36 | 0.35 |
| iC_{4═}/iC₄ | 4.80 | 7.74 |

### Example 2: ACE Testing of AXL Crude Oil with the Cracking Catalyst Composition

In Example 2, the performance of the cracking catalyst composition of Example 1 was evaluated for cracking AL crude oil under various reaction conditions. The properties of AL crude oil utilized in the examples were previously shown in Table 1. The catalytic cracking of AL crude oil with the cracking catalyst composition of Example 1 was carried out in an ACE testing unit. The cracking catalyst composition of Example 1 of was evaluated for cracking AL crude oil according to the Advanced Cracking Evaluation (ACE) test procedure. Prior to evaluation, the cracking catalyst composition of Example 1 was heated to 650° C. and 675° C. and fluidized using nitrogen. The experiments were conducted in the ACE unit of FIG. 3 at 75 seconds time-on-stream (TOS) and a catalyst-to-oil (CTO) weight ratio of 8.11 and 8.14.

After each reaction, the cracking catalyst composition was stripped using nitrogen (N₂). During the regeneration of the cracking catalyst composition, the gas product was sent to a CO₂ analyzer to determine the amount of coke present.

The ACE results from the cracking of AL crude oil over the cracking catalyst composition of Example 1 are shown in Table 3. As can be seen, high light olefin yields of greater than 39 wt. %, high propylene yields of greater than 18 wt. %, and high light aromatic yields of greater than 28 wt. % were obtained using the cracking catalyst composition. Reaction conditions of 675° C. achieved the greatest light olefin yield of 41.56 wt. % and the greatest propylene yield of 18.46 wt. % (Ex. 2-2). Reaction conditions of 650° C. achieved the greatest light aromatic compound yield of 30.67 wt. % (Ex. 2-1).

TABLE 3
ACE Data for Cracking AXL Crude Oil

| | Ex. 2-1 | Ex. 2-2 |
|---|---|---|
| Temperature (° C.) | 650 | 675 |
| Injection Time (s) | 75 | 75 |
| Catalyst | 75 wt. % Y- | 75 wt. % Y- |
| | zeolite | zeolite |
| | particles, | particles, |
| | 25 wt. % | 25 wt. % |
| | cracking | cracking |
| | additive | additive |
| | particles | particles |
| Steaming conditions | 810° C., 6 h | 810° C., 6 h |
| Feed code | AXL Crude | AXL Crude |
| catalyst to oil ratio (CTO) | 8.11 | 8.14 |
| Conversion (%) | 88.78 | 90.54 |

Yields (wt. %)

| | | |
|---|---|---|
| Hydrogen (H₂) | 0.35 | 0.41 |
| Methane (C₁) | 4.02 | 6.03 |
| Ethane (C₂) | 3.34 | 4.25 |
| Ethylene (C_{2═}) | 12.65 | 14.40 |
| Propane (C₃) | 3.70 | 2.86 |
| Propylene (C_{3═}) | 18.24 | 18.46 |
| Isobutane (iC₄) | 0.92 | 0.57 |
| Normal butane (nC₄) | 1.52 | 1.07 |
| Trans-2-butene (t2C_{4═}) | 2.11 | 1.88 |
| 1-Butene (1C_{4═}) | 1.44 | 1.40 |
| Isobutene (iC_{4═}) | 3.18 | 3.09 |
| Cis-2-butene (c2C_{4═}) | 1.68 | 1.52 |
| 1,3-butadiene | 0.44 | 0.82 |
| Total Gases | 53.58 | 56.75 |
| Gasoline | 30.67 | 28.89 |
| Light cycle oil (LCO) | 8.21 | 7.33 |
| Heavy cycle oil (HCO) | 3.01 | 2.13 |
| Coke | 4.53 | 4.90 |

Groups (wt. %)

| | | |
|---|---|---|
| Dry Gas (H₂ − C₂) | 20.36 | 25.09 |
| LPG (C₃ − C₄) | 33.22 | 31.66 |
| Light olefins (C_{2═} − C_{4═}) | 39.73 | 41.56 |
| C_{3═} + C_{4═} | 27.08 | 27.16 |
| Butenes (C_{4═}) | 8.84 | 8.70 |

Molar Ratios (mol/mol)

| | | |
|---|---|---|
| C_{2═}/C₂ | 4.06 | 3.63 |
| C_{3═}/C₃ | 5.16 | 6.77 |
| C_{4═}/C₄ | 3.76 | 5.47 |
| iC_{4═}/C_{4═} | 0.36 | 0.36 |
| iC_{4═}/iC₄ | 3.58 | 5.57 |

### Example 3: MAT Testing of AL Crude Oil with the Cracking Catalyst Composition

In Example 3, the performance of the cracking catalyst composition of Example 1 was evaluated for cracking AL crude oil under various reaction conditions. The properties of AL crude oil utilized in the examples were previously shown in Table 1. In Example 3, the catalytic cracking of AL crude oil with the cracking catalyst composition of Example 1 was carried out in a Sakuragi Rikagaku (Japan) Micro Activity Test (MAT) instrument using a quartz tubular reactor. The cracking catalyst composition of Example 1 was evaluated for cracking AL crude oil according to standard test method ASTM D-3907. Prior to evaluation, the cracking catalyst composition was steamed at 810° C. for 6 hours prior to conducting the cracking reactions. The experiments were conducted in the MAT unit at 30 seconds time-on-stream (TOS). The cracking reactions were conducted at temperatures of 625° C. and 640° C. and at catalyst-to-oil weight ratios of 8.10 and 8.22.

After each reaction, the cracking catalyst composition was stripped using nitrogen (N₂) at a flow rate of 30 cubic centimeters per minute (cm³/min). The liquid product was collected in a liquid receiver and the gaseous products were collected in a gas burette by water displacement and sent to the gas chromatograph (GC) for analysis. The used catalysts were used to measure the amount of generated coke from the reaction.

The MAT results from the cracking of AL crude oil over the cracking catalyst composition of Example 1 are shown in Table 4. As can be seen, high light olefin yields of greater than 36 wt. %, high propylene yields of greater than 16 wt. %, and high light aromatic compound yields of greater than 29 wt. % were obtained using the cracking catalyst composition of Example 1. Reaction conditions of 640° C. and a catalyst-to-oil ratio of 8.22 achieved the greatest light olefin yield of 36.72 wt. % and the greatest light aromatic compound yield of 30.59 wt. % (Ex. 3-2). Reaction conditions of 625° C. and a catalyst-to-oil ratio of 8.10 achieved the greatest propylene yield of 17.63 wt. % (Ex. 3-1).

TABLE 4
MAT data for cracking AL crude oil

| | Ex. 3-1 | Ex. 3-2 |
|---|---|---|
| Temperature (° C.) | 625 | 640 |
| Injection Time (s) | 30 | 30 |
| Catalyst | 75 wt. % Y- | 75 wt. % Y- |
| | zeolite | zeolite |
| | particles, | particles, |
| | 25 wt. % | 25 wt. % |
| | cracking | cracking |
| | additive | additive |
| | particles | particles |
| Steaming conditions | 810° C., 6 h | 810° C., 6 h |
| Feed code | AL Crude | AL Crude |
| catalyst to oil ratio (CTO) | 8.10 | 8.22 |
| Conversion (%) | 85.46 | 87.67 |

Yields (mass %)

| | | |
|---|---|---|
| Hydrogen (H₂) | 0.246 | 0.266 |
| Methane (C₁) | 3.63 | 3.69 |
| Ethane (C₂) | 3.50 | 3.46 |
| Ethylene (C_{2═}) | 10.55 | 12.50 |
| Propane (C₃) | 4.58 | 5.24 |
| Propylene (C_{3═}) | 17.63 | 16.91 |
| Isobutane (iC₄) | 1.59 | 1.43 |
| Normal butane (nC₄) | 1.75 | 1.52 |
| Trans-2-butene (t2C_{4═}) | 1.95 | 1.68 |
| 1-Butene (1C_{4═}) | 1.73 | 1.49 |
| Isobutene (iC_{4═}) | 3.16 | 2.64 |
| Cis-2-butene (c2C_{4═}) | 1.62 | 1.40 |
| 1,3-butadiene | 0.091 | 0.102 |
| Total Gases | 52.08 | 52.32 |
| Gasoline | 29.41 | 30.59 |
| Light cycle oil (LCO) | 10.17 | 9.72 |
| Heavy cycle oil (HCO) | 4.37 | 2.61 |
| Coke | 3.97 | 4.76 |

Groups (mass %)

| | | |
|---|---|---|
| Dry Gas (H₂ − C₂) | 17.93 | 19.91 |
| LPG (C₃ − C₄) | 34.14 | 32.41 |
| Light olefins (C_{2═} − C_{4═}) | 36.77 | 36.72 |
| C_{3═} + C_{4═} | 26.22 | 24.22 |
| Butenes (C_{4═}) | 8.59 | 7.31 |

Molar ratio (mol/mol)

| | | |
|---|---|---|
| C_{2═}/C₂ | 3.23 | 3.87 |
| C_{3═}/C₃ | 4.03 | 3.38 |
| C_{4═}/C₄ | 2.67 | 2.57 |
| iC_{4═}/C_{4═} | 0.368 | 0.361 |
| iC_{4═}/iC₄ | 1.98 | 1.92 |

### Example 4: MAT Testing of AXL Crude Oil with the Cracking Catalyst Composition

In Example 4, the performance of the cracking catalyst composition described in Example 1 was evaluated for cracking AXL crude oil under various reaction conditions. The properties of AXL crude oil utilized in the examples were previously shown in Table 1. In Example 4, the catalytic cracking of AXL crude oil with the cracking catalyst composition of Example 1 was carried out in a Sakuragi Rikagaku (Japan) Micro Activity Test (MAT) instrument using a quartz tubular reactor. The cracking catalyst composition of Example 1 was evaluated for cracking AXL crude oil according to standard test method ASTM D-3907. Prior to evaluation, the cracking catalyst composition was steamed at 810° C. for 6 hours prior to conducting the cracking reactions. The experiments were conducted in the MAT unit at 30 seconds time-on-stream (TOS). The cracking reactions were conducted at temperatures of 600° C., 625° C., and 650° C. and at CTO weight ratios of around 4.5 and 7.5.

After each reaction, the cracking catalyst composition was stripped using nitrogen (N₂) at a flow rate of 30 cubic centimeters per minute (cm³/min). The liquid product was collected in a liquid receiver and the gaseous products were collected in a gas burette by water displacement and sent to the gas chromatograph (GC) for analysis. The used catalysts were used to measure the amount of generated coke from the reaction.

The MAT results from the cracking of AXL crude oil over the cracking catalyst composition described in Example 1 are shown in Table 5. As can be seen, high light olefin yields of greater than 32 wt. %, high propylene yields of greater than 15 wt. %, and high light aromatic compound yields of greater than 29 wt. % were obtained using the cracking catalyst composition of Example 1. Reaction conditions of 650° C. and a CTO ratio of 7.75 achieved the greatest light olefin yield of 43.92 wt. % and the greatest propylene yield of 20.63 wt. % (Ex. 4-6). Reaction conditions of 600° C. and a CTO ratio of 4.72 achieved the greatest light aromatic compounds yield of 42.69 wt. % (Ex. 4-6).

TABLE 5
MAT Data for Cracking AXL Crude Oil

| | Ex. 4-1 | Ex. 4-2 | Ex. 4-3 | Ex. 4-4 | Ex. 4-5 | Ex. 4-6 |
|---|---|---|---|---|---|---|
| Temperature(° C.) | 600.00 | 625.00 | 650.00 | 600.00 | 625.00 | 650.00 |
| Injection Time(s) | 30.00 | 30.00 | 30.00 | 30.00 | 30.00 | 30.00 |
| Catalyst | 75 wt. % | 75 wt. % | 75 wt. % | 75 wt. % | 75 wt. % | 75 wt. % |
| | Y-zeolite | Y-zeolite | Y-zeolite | Y-zeolite | Y-zeolite | Y-zeolite |
| | particles, | particles, | particles, | particles, | particles, | particles, |
| | 25 wt. % | 25 wt. % | 25 wt. % | 25 wt. % | 25 wt. % | 25 wt. % |
| | cracking | cracking | cracking | cracking | cracking | cracking |
| | additive | additive | additive | additive | additive | additive |
| | particles | particles | particles | particles | particles | particles |
| Steaming | 810° C., | 810° C., | 810° C., | 810° C., | 810° C., | 810° C., |
| conditions | 6 h | 6 h | 6 h | 6 h | 6 h | 6 h |
| Feed code | AXL | AXL | AXL | AXL | AXL | AXL |
| Catalyst to oil | 4.72 | 4.67 | 4.53 | 7.47 | 7.57 | 7.75 |
| ratio (CTO) | | | | | | |
| Conversion (%) | 89.69 | 89.40 | 88.58 | 92.40 | 92.27 | 91.79 |

Yields (wt. %)

| | | | | | | |
|---|---|---|---|---|---|---|
| Hydrogen (H₂) | 0.13 | 0.14 | 0.17 | 0.21 | 0.19 | 0.24 |
| Methane (C₁) | 1.38 | 1.90 | 2.55 | 1.91 | 2.35 | 3.35 |
| Ethane (C₂) | 1.57 | 1.93 | 2.41 | 2.18 | 2.48 | 3.14 |
| Ethylene (C_{2═}) | 7.99 | 9.72 | 10.94 | 10.81 | 12.36 | 14.43 |
| Propane (C₃) | 5.31 | 4.72 | 3.91 | 7.80 | 6.58 | 5.65 |
| Propylene | 15.23 | 18.20 | 19.57 | 16.85 | 18.64 | 20.63 |
| (C_{3═}) | | | | | | |
| Isobutane (iC₄) | 2.60 | 2.09 | 1.38 | 3.75 | 2.82 | 1.98 |
| Normal butane | 1.95 | 1.76 | 1.42 | 2.62 | 2.18 | 1.76 |
| (nC₄) | | | | | | |
| Trans-2-butene | 2.00 | 2.27 | 2.29 | 2.01 | 2.05 | 2.05 |
| (t2C_{4═}) | | | | | | |
| 1-Butene (1C_{4═}) | 1.59 | 1.91 | 2.01 | 1.63 | 1.75 | 1.85 |
| Isobutene (iC_{4═}) | 3.25 | 3.64 | 3.62 | 3.16 | 3.21 | 3.17 |
| Cis-2-butene | 1.49 | 1.71 | 1.73 | 1.50 | 1.55 | 1.57 |
| (c2C_{4═}) | | | | | | |
| 1,3-butadiene | 0.07 | 0.12 | 0.16 | 0.07 | 0.11 | 0.16 |
| Total Gases | 45.32 | 50.51 | 52.43 | 54.77 | 56.41 | 60.05 |
| Gasoline | 42.69 | 37.35 | 34.87 | 35.99 | 34.01 | 29.91 |
| Light cycle oil | 7.82 | 8.17 | 8.76 | 5.75 | 5.91 | 6.29 |
| (LCO) | | | | | | |
| Heavy cycle oil | 2.49 | 2.43 | 2.66 | 1.85 | 1.82 | 1.92 |
| (HCO) | | | | | | |
| Coke | 1.68 | 1.54 | 1.28 | 1.64 | 1.85 | 1.82 |

Groups (wt. %)

| | | | | | | |
|---|---|---|---|---|---|---|
| Dry Gas | 11.07 | 13.69 | 16.08 | 15.11 | 17.37 | 21.17 |
| (H₂ − C₂) | | | | | | |
| LPG (C₃ − C₄) | 34.25 | 36.82 | 36.35 | 39.66 | 39.04 | 38.88 |
| Light olefins | 32.38 | 37.97 | 40.58 | 36.30 | 39.81 | 43.92 |
| (C_{2═} − C_{4═}) | | | | | | |
| C_{3═} + C_{4═} | 24.39 | 28.25 | 29.64 | 25.50 | 27.46 | 29.49 |
| Butenes (C_{4═}) | 9.16 | 10.05 | 10.07 | 8.64 | 8.81 | 8.86 |

Molar ratio (mol/mol)

| | | | | | | |
|---|---|---|---|---|---|---|
| C_{2═}/C₂ | 5.47 | 5.40 | 4.86 | 5.30 | 5.34 | 4.92 |
| C_{3═}/C₃ | 3.01 | 4.04 | 5.25 | 2.26 | 2.97 | 3.82 |
| C_{4═}/C₄ | 2.09 | 2.71 | 3.73 | 1.41 | 1.83 | 2.46 |
| iC_{4═}/C_{4═} | 0.35 | 0.36 | 0.36 | 0.37 | 0.36 | 0.36 |
| iC_{4═}/iC₄ | 1.30 | 1.81 | 2.73 | 0.87 | 1.18 | 1.66 |

As seen in Table 5, increasing the catalyst-to-oil ratio at a fixed temperature resulted in an increased yield of propylene (C₃₌) and total yield of light olefins. Increasing the reaction temperature from 600° C. to 625° C. to 650° C. resulted in an increased propylene, ethylene, and light olefins yield.

### Comparative Example 5

In Comparative Example 5, the performance of commercial cracking catalysts were evaluated for cracking AL crude oil at a reaction temperature of 625° C. and catalyst-to-oil weight ratio of about 9. For Comparative Example 5-1, the commercial cracking catalyst was a commercial catalyst based on ZSM-5 zeolite available as OLEFINSULTRA® MZ cracking additive obtained from Grace GMBH of Worms, Germany. For Comparative Example 5-2, the commercial catalyst was a Y-zeolite equilibrium catalyst. The catalytic cracking of AL crude oil with the commercial cracking catalysts of Comparative Examples 5-1 and 5-2 were carried out as described in Examples 3 and 4. The MAT results from the cracking of AL crude oil over the commercial cracking catalysts of Comparative Examples 5-1 and 5-2 are shown in Table 6.

TABLE 6
Comparative Data for Cracking AL Crude Oil

| | Comp. | Comp. | |
|---|---|---|---|
| | Ex. 5-1 | Ex. 5-2 | Ex. 3-1 |
| Temperature (° C.) | 625 | 625 | 625 |
| Catalyst | Commercial | Commercial | 75 wt. % Y- |
| | catalyst | catalyst | zeolite |
| | based on | based on | particles, |
| | ZSM-5 | Y-zeolite | 25 wt. % |
| | zeolite | | cracking |
| | | | additive |
| | | | particles |
| Steaming conditions | 810° C., 6 h | 810° C., 6 h | 810° C., 6 h |
| Feed code | AL Crude | AL Crude | AL Crude |
| catalyst to oil ratio (CTO) | 9.22 | 9.18 | 8.10 |
| Conversion (%) | 43.01 | 56.15 | 85.46 |

Yields (mass %)

| | | | |
|---|---|---|---|
| Hydrogen (H₂) | 0.273 | 0.265 | 0.246 |
| Methane (C₁) | 3.08 | 3.00 | 3.63 |
| Ethane (C₂) | 3.45 | 3.10 | 3.50 |
| Ethylene (C_{2═}) | 9.50 | 10.86 | 10.55 |
| Propane (C₃) | 6.43 | 6.36 | 4.58 |
| Propylene (C_{3═}) | 9.95 | 14.74 | 17.63 |
| Isobutane (iC₄) | 0.95 | 2.54 | 1.59 |
| Normal butane (nC₄) | 1.12 | 1.90 | 1.75 |
| Trans-2-butene (t2C_{4═}) | 0.89 | 1.53 | 1.95 |
| 1-Butene (1C_{4═}) | 0.82 | 1.34 | 1.73 |
| Isobutene (iC_{4═}) | 1.44 | 2.44 | 3.16 |
| Cis-2-butene (c2C_{4═}) | 0.74 | 1.27 | 1.62 |
| 1,3-butadiene | 0.145 | 0.566 | 0.091 |
| Total Gases | 38.84 | 49.96 | 52.08 |
| Gasoline | 25.61 | 29.08 | 29.41 |
| Light cycle oil (LCO) | 17.71 | 10.91 | 10.17 |
| Heavy cycle oil (HCO) | 13.67 | 3.87 | 4.37 |
| Coke | 4.17 | 6.19 | 3.97 |

Groups (mass %)

| | | | |
|---|---|---|---|
| Dry Gas (H₂ − C₂) | 16.30 | 17.23 | 17.93 |
| LPG (C₃ − C₄) | 22.54 | 32.73 | 34.14 |
| Light olefins (C2═ − C_{4═}) | 23.54 | 32.79 | 36.77 |
| C_{3═} + C_{4═} | 14.03 | 21.93 | 26.22 |
| Butenes (C_{4═}) | 4.08 | 7.19 | 8.59 |

As can be seen in Table 5, the yields of the total light olefins, propylene, and light aromatic compounds using the FCC catalyst composition of Example 3 (Ex. 3-1) were greater than the yields of the total light olefins, propylene, and light aromatic compounds using the catalysts of Comparative Examples 5-1 or 5-2 under similar conditions. Similarly, while the CTO is less in Ex. 3-1 compared to Comparative Examples 5-1 or 5-2, there is still an increase in overall conversion and yield of olefins and propylene. It would be expected that a decrease in CTO would correspond to a decrease in conversion and yield due to there being proportionally less catalyst to crack the feed on. However, the cracking catalyst of the present disclosure shows overall greater conversion and yields of light olefins, propylene, and light aromatic compounds. Ex. 3-1 illustrates that proportionally less of the cracking catalyst composition is required to achieve the same or better conversion and yield of light olefins and light aromatic compounds compared to prior art catalysts.

According to a first aspect of the present disclosure, a process for upgrading crude oil may include passing a crude oil feed to a catalytic cracking system. The crude oil feed may be a whole crude oil or a desalted crude oil. The catalytic cracking system may include a cracking reactor. The process may further include contacting the crude oil feed with a cracking catalyst composition in the cracking reactor at high-severity reaction conditions. The cracking catalyst composition may include a mixture of Y-zeolite particles and cracking additive particles. The Y-zeolite particles may include silicon dioxide, aluminum oxide, iron (III) oxide, titanium (IV) oxide, phosphorous (V) pentoxide, sodium dioxide, and aluminum sulfate. The cracking additive particles may include ZSM-5 zeolite particles, aluminum phosphate, calcined Kaolin clay, aluminum oxide, and quartz. Contacting the crude oil feed with the cracking catalyst composition may cause at least a portion of hydrocarbons in the crude oil feed to undergo one or more cracking reactions, producing a cracking effluent and a used cracking catalyst composition. The cracking effluent may include light olefins, light aromatic compounds, or both.

A second aspect of the present disclosure may include the first aspect, where the Y-zeolite particles may include: 72 wt. % to 82 wt. % silicon dioxide, or 76 wt. % to 80 wt. % silicon dioxide; 16 wt. % to 24 wt. % aluminum oxide, or 18 wt. % to 22 wt. % aluminum oxide; 0.0 wt. % to 0.9 wt. % iron (III) oxide, or 0.1 wt. % to 0.9 wt. % iron (III) oxide; 0.0 wt. % to 0.9 wt. % titanium (IV) oxide, or 0.1 wt. % to 0.9 wt. % titanium (IV) oxide; 0.0 wt. % to 0.8 wt. % phosphorous (V) oxide, or 0.1 wt. % to 0.8 wt. % phosphorous (V) oxide; and 0.0 wt. % to 0.5 wt. % sodium dioxide, or 0.1 wt. % to 0.5 wt. % sodium dioxide.

A third aspect of the present disclosure may include either one of the first or second aspects, where the Y-zeolite particles may include a molar ratio of silicon dioxide to aluminum oxide of greater than 2, such as from 3 to 30.

A fourth aspect of the present disclosure may include any one of the first through third aspects, where the iron (III) oxide, titanium (IV) oxide, phosphorous (V) pentoxide, sodium dioxide, and aluminum sulfate may be available on the surface of the Y-zeolite particles.

The fifth aspect of the present disclosure may include any one of the first through fourth aspects, where the Y-zeolite particles may include an average surface area of greater than 200 m²/g, such as greater than 500 m²/g or from 200 m²/g to 800 m²/g.

The sixth aspect of the present disclosure may include any one of the first through fifth aspects, where the Y-zeolite particles may include a total pore volume of from 0.4 cm³/g to 0.7 cm³/g, such as from 0.5 cm³/g to 0.55 cm³/g.

The seventh aspect of the present disclosure may include any of the first through sixth aspects, where the Y-zeolite particles may include an average particle size of from 0.1 microns to 100 microns.

The eighth aspect of the present disclosure may include any of the first through seventh aspects, where the cracking additive particles may include: 50 wt. % to 70 wt. % ZSM-5 zeolite particles; 25 wt. % to 50 wt. % calcined Kaolin clay; 10 wt. % to 25 wt. % aluminum phosphate; 2.5 wt. % to 10 wt. % aluminum oxide; and less than 1 wt. % quartz.

The ninth aspect of the present disclosure may include any of the first through eighth aspects, where the cracking additive particles may include a molar ratio of silicon dioxide to aluminum oxide of greater than 5, such as from 5 to 50.

The tenth aspect of the present disclosure may include any one of the first through ninth aspects, where the ZSM-5 zeolite particles may include an average surface area from 200 m²/g to 800 m²/g, such as from 400 m²/g to 600 m²/g.

The eleventh aspect of the present disclosure may include any one of the first through tenth aspects, where the cracking additive particles may include a density of 1 g/cm³ and an average particle size of from 0.1 microns to 100 microns.

The twelfth aspect of the present disclosure may include any one of the first through eleventh aspects, where the crude oil feed may be Arab Extra Light crude oil, Arab Light crude oil, or a mixture of Arab Extra Light crude oil and Arab Light crude oil. The crude oil feed may also include paraffin compounds, aromatic compounds, naphthenes, sulfur, sodium, nitrogen, vanadium, nickel, and iron.

The thirteenth aspect of the present disclosure may include any one of the first through twelfth aspects, where the crude oil feed may have an American Petroleum Institute gravity from 15 degrees to 50 degrees, or from 36 degrees to 44 degrees.

The fourteenth aspect of the present disclosure may include any one of the first through thirteenth aspects, where the crude oil feed may have a density of greater than 0.8 g/cm³ at 15 degrees Celsius, such as from 0.8 g/cm³ to 0.86 g/cm³.

The fifteenth aspect of the present disclosure may include any of the first through fourteenth aspects, where the crude oil feed may have an initial boiling point from 30° C. to 40° C. and an end boiling point greater than 600° C., such as from 600° C. to 720° C.

The sixteenth aspect of the present disclosure may include any of the first through fifteenth aspects, where at least 50 wt. % of the crude oil feed may have a boiling point temperature less than 300° C., or less than or equal to 295° C., or from 200° C. to 300° C.

The seventeenth aspect of the present disclosure may include any of the first through sixteenth aspects, where the crude oil feed may have a concentration of paraffin compounds of less than 50 wt. % per unit weight of the crude oil feed, such as from 5 wt. % to 50 wt. % per unit weight of the crude oil feed.

The eighteenth aspect of the present disclosure may include any of the first through seventeenth aspects, where the crude oil feed may have a concentration of aromatic compounds of greater than or equal to 20 wt. % per unit weight of the crude oil feed, such as from 20 wt. % to 90 wt. % per unit weight of the crude oil feed.

The nineteenth aspect of the present disclosure may include any of the first through eighteenth aspects, where the crude oil feed may have a concentration of naphthenes of greater than or equal to 25 wt. % per unit weight of the crude oil feed, such as from 25 wt. % to 60 wt. % per unit weight of the crude oil feed.

The twentieth aspect of the present disclosure may include any of the first through nineteenth aspects, where the crude oil feed may include Arab Extra Light crude oil, and the conversion of Arab Extra Light crude oil may be greater than or equal to 90%, or even greater than or equal to 92%.

The twenty-first aspect of the present disclosure may include any of the first through twentieth aspects, where the crude oil feed may include Arab Light crude oil, and the conversion of Arab Light crude oil may be greater than or equal to 85%, or even greater than or equal to 88%, such as from 85% to 100% conversion.

The twenty-second aspect of the present disclosure may include any of the first through twenty-first aspects, where the cracking catalyst composition may include greater than 60 wt. % of the Y-zeolite particles, such as from 70 to 90 wt. %, based on the total weight of the cracking catalyst composition, and the cracking catalyst composition may include up to 40 wt. % of the cracking additive particles, such as from 5 wt. % to 30 wt. %, based on the total weight of the cracking catalyst composition.

The twenty-third aspect of the present disclosure may include any of the first through twenty-second aspects, where the cracking catalyst composition may include 75 wt. % of the Y-zeolite particles and 25 wt. % of the cracking additive particles based on the total weight of the cracking catalyst composition.

The twenty-fourth aspect of the present disclosure may include any of the first through twenty-third aspects, where catalytic cracking system may be a fluidized catalytic cracking (FCC) system comprising an FCC reactor, a fluid-solid separator disposed at an outlet of the FCC reactor, and a catalyst regenerator downstream of the fluid-solid separator.

The twenty-fifth aspect of the present disclosure may include the twenty-fourth aspect, further including separating the cracking effluent from the used cracking catalyst composition in the fluid-solid separator.

The twenty-sixth aspect of the present disclosure may include either one of the twenty-fourth or twenty-fifth aspects, further including regenerating the used cracking catalyst composition to produce a regenerated cracking catalyst composition and passing the regenerated cracking catalyst composition back to the FCC reactor as at least a portion of or all of the cracking catalyst composition.

The twenty-seventh aspect of the present disclosure may include any of the twenty-fourth through twenty-sixth aspects, including contacting the crude oil feed with the cracking catalyst composition at a cracking temperature of from 580° C. to 750° C., such as from 600° C. to 700° C., or from 625° C. to 680° C.

The twenty-eighth aspect of the present disclosure may include any of the twenty-fourth through twenty-seventh aspects, including contacting the crude oil with the cracking catalyst composition in the FCC reactor at a catalyst-to-oil weight ratio of from 1 to 60. The catalyst to oil weight ratio may be the mass flow rate of cracking catalyst composition passed to the FCC reactor divided by the mass flow rate of the crude oil passed to the FCC reactor.

The twenty-ninth aspect of the present disclosure may include any of the twenty-fourth through twenty-eighth aspects, including contacting the crude oil with the cracking catalyst composition in the FCC reactor for a contact time of from 0.1 seconds to 60 seconds. The contact time may be an average time that hydrocarbons are in contact with the cracking catalyst composition at the cracking temperature.

The thirtieth aspect of the present disclosure may include any one of the first through twenty-ninth aspects, where the catalytic cracking system may be a fixed bed catalytic cracking system comprising a fixed bed cracking reactor. The cracking catalyst composition may be in a fixed catalyst bed contained within the fixed bed cracking reactor.

The thirty-first aspect of the present disclosure may include the thirtieth aspect, where the fixed bed cracking reactor may include a plurality of fixed bed reactors.

The thirty-second aspect of the present disclosure may include either one of the thirtieth or thirty-first aspects, where the fixed bed cracking reactor may include a porous packing material.

The thirty-third aspect of the present disclosure may include any one of the thirtieth through thirty-second aspects, including preheating the crude oil feed to a preheat temperature of from 35° C. to 150° C., from 40° C. to 145° C., or from 45° C. to 140° C.

The thirty-fourth aspect of the present disclosure may include any one of the thirtieth through thirty-third aspects, including injecting water into the fixed bed cracking reactor at a steam temperature of from 50° C. to 175° C., or from 60° C. to 170° C.

The thirty-fifth aspect of the present disclosure may include any one of the thirtieth through thirty-fourth aspects, including contacting the crude oil feed with the cracking catalyst composition at a cracking temperature of from 525° C. to 800° C., from 550° C. to 750° C., or from 600° C. to 700° C.

The thirty-sixth aspect of the present disclosure may include any one of the thirtieth through thirty-fifth aspects, further including regenerating the used cracking catalyst composition to produce a regenerated cracking catalyst composition and passing the regenerated cracking catalyst composition back to the fixed bed cracking reactor as at least a portion of or all of the cracking catalyst composition.

The thirty-seventh aspect of the present disclosure may include any of the first through thirty-sixth aspects, where the process may not include hydrotreating the crude oil feed upstream of the catalytic cracking system.

The thirty-eighth aspect of the present disclosure may include any one of the first through thirty-seventh aspects, where the process may not include subjecting the crude oil feed to a separation by boiling point difference to remove one or more constituents from the crude oil feed upstream of the catalytic cracking system.

It is noted that any two quantitative values assigned to a property may constitute a range of that property, and all combinations of ranges formed from all stated quantitative values of a given property are contemplated in this disclosure.

It is noted that one or more of the following claims utilize the term “where” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific aspects, it is noted that the various details of such aspects should not be taken to imply that these details are essential components of the aspects. Rather, the claims appended hereto should be taken as the sole representation of the breadth of the present disclosure and the corresponding scope of the various aspects described in this disclosure. Further, it will be apparent that modifications and variations are possible without departing from the scope of the appended claims.

What is claimed is:

1. A process for upgrading crude oil, the process comprising:
passing a crude oil feed to a catalytic cracking system comprising a cracking reactor, where the crude oil feed is a whole crude oil or a desalted crude oil;
contacting the crude oil feed with a cracking catalyst composition in the cracking reactor at high-severity reaction conditions, where:
the cracking catalyst composition comprises a mixture of Y-zeolite particles and cracking additive particles;
the Y-zeolite particles comprise silicon dioxide, aluminum oxide, iron (III) oxide, titanium (IV) oxide, phosphorous (V) pentoxide, sodium dioxide, and aluminum sulfate;
the cracking additive particles comprise ZSM-5 zeolite particles, aluminum phosphate, calcined Kaolin clay, aluminum oxide, and quartz;
the contacting causes at least a portion of hydrocarbons in the crude oil feed to undergo one or more cracking reactions to produce a cracking effluent and a used cracking catalyst composition; and
the cracking effluent comprises light olefins, light aromatic compounds, or both.

2. The process of claim 1, where the Y-zeolite particles comprise:
72 wt. % to 82 wt. % silicon dioxide;
16 wt. % to 24 wt. % aluminum oxide;
0.0 wt. % to 0.9 wt. % iron (III) oxide;
0.0 wt. % to 0.9 wt. % titanium (IV) oxide;
0.0 wt. % to 0.8 wt. % phosphorous (V) oxide; and
0.0 wt. % to 0.5 wt. % sodium dioxide.

3. The process of claim 1, where the Y-zeolite particles have a molar ratio of silicon dioxide to aluminum oxide of greater than 2.

4. The process of claim 1, where the iron (III) oxide, titanium (IV) oxide, phosphorous (V) pentoxide, sodium dioxide, and aluminum sulfate are available on a surface of the Y-zeolite particles.

5. The process of claim 1, where the Y-zeolite particles have a specific surface area of greater than 200 m²/g.

6. The process of claim 1, where the Y-zeolite particles have a total pore volume of from 0.4 cm³/g to 0.7 cm³/g.

7. The process of claim 1, where the Y-zeolite particles have an average particle size of from 0.1 microns to 100 microns.

8. The process of claim 1, where the cracking additive particles comprise:
50 wt. % to 70 wt. % ZSM-5 zeolite particles;
25 wt. % to 50 wt. % calcined Kaolin clay;
10 wt. % to 25 wt. % aluminum phosphate;
2.5 wt. % to 10 wt. % aluminum oxide; and
less than 1 wt. % quartz.

9. The process of claim 1, where the cracking additive particles have a molar ratio of silicon dioxide to aluminum oxide of greater than 5.

10. The process of claim 1, where the ZSM-5 zeolite particles have a specific surface area from 200 m²/g to 800 m²/g.

11. The process of claim 1, where the cracking additive particles have a density of 1 g/cm³ and an average particle size of from 0.1 microns to 100 microns.

12. The process of claim 1, where:
the crude oil feed is Arab Extra Light crude oil, Arab Light crude oil, or a mixture of Arab Extra Light crude oil and Arab Light crude oil; and
the crude oil feed comprises paraffin compounds, aromatic compounds, naphthenes, sulfur, sodium, nitrogen, vanadium, nickel, and iron.

13. The process of claim 1, where the crude oil feed comprises Arab Extra Light crude oil, and the conversion of Arab Extra Light crude oil is greater than or equal to 90%.

14. The process of claim 1, where the crude oil feed comprises Arab Light crude oil, and the conversion of Arab Light crude oil is greater than or equal to 85%.

15. The process of claim 1, where the cracking catalyst composition comprises greater than 60 wt. % of the Y-zeolite particles based on the total weight of the cracking catalyst composition, and the cracking catalyst composition comprises up to 40 wt. % of the cracking additive particles based on the total weight of the cracking catalyst composition.

16. The process of claim 1, where catalytic cracking system is a fluidized catalytic cracking (FCC) system comprising an FCC reactor, a fluid-solid separator disposed at an outlet of the FCC reactor, and a catalyst regenerator downstream of the fluid-solid separator.

17. The process of claim 16, further comprising separating the cracking effluent from the used cracking catalyst composition in the fluid-solid separator, regenerating the used cracking catalyst composition to produce a regenerated cracking catalyst composition, passing the regenerated cracking catalyst composition back to the FCC reactor as at least a portion of or all of the cracking catalyst composition.

18. The process of claim 1, where the catalytic cracking system is a fixed bed catalytic cracking system comprising a fixed bed cracking reactor, where the cracking catalyst composition is in a fixed catalyst bed contained within the fixed bed cracking reactor.

19. The process of claim 18, further comprising regenerating the used cracking catalyst composition to produce a regenerated cracking catalyst composition and passing the regenerated cracking catalyst composition back to the fixed bed cracking reactor as at least a portion of or all of the cracking catalyst composition.

20. The process of claim 1, where the process does not include hydrotreating the crude oil feed upstream of the catalytic cracking system.
